(19) United States
(12) Patent Application Publication
(10) Pub. No.: US 2025/0273070 A1
(43) Pub. Date: Aug. 28, 2025

(54) REDUCING VULNERABLE ROAD USER (VRU) MESSAGE OVERHEAD AND PRESENTATION COMPLEXITY

(71) Applicant: QUALCOMM Incorporated, San Diego, CA (US)

(72) Inventors: Deviprasad PUTCHALA, San Diego, CA (US); Chaitanya MEHTA, San Diego, CA (US); Nam Soo PARK, San Diego, CA (US); Dan VASSILOVSKI, Del Mar, CA (US); Gene Wesley MARSH, San Diego, CA (US); Marc ADAMS, El Cajon, CA (US)

(21) Appl. No.: 19/059,181

(22) Filed: Feb. 20, 2025

Related U.S. Application Data
(60) Provisional application No. 63/557,432, filed on Feb. 23, 2024.

(51) Int. Cl. G08G 1/0967; G08G 1/052; G08G 1/056; H04W 4/02; H04W 4/40

(52) U.S. Cl. CPC G08G 1/096791; G08G 1/052; G08G 1/056; H04W 4/025; H04W 4/40

(57) ABSTRACT

Disclosed are systems, apparatuses, processes, and computer-readable media for wireless communications. For example, a process may include receiving, at a server, a vulnerable-road-user (VRU) report from a VRU user equipment (UE), the VRU report including information associated with at least one of a location of the VRU UE, a speed of the VRU UE, or a heading of the VRU UE; determining, based on the VRU report, VRU context information associated with the VRU UE; determining, based on the VRU context information, an updated VRU-message reporting frequency for the VRU UE; and transmitting, to the UE, information indicating the updated VRU-message reporting frequency.

### CROSS-REFERENCE TO RELATED APPLICATIONS

This application claims the benefit of U.S. Provisional Application No. 63/557,432, titled REDUCING VULNERABLE ROAD USER (VRU) MESSAGE OVERHEAD AND PRESENTATION COMPLEXITY, filed Feb. 23, 2024, which is incorporated herein by reference in its entirety.

### FIELD

The present disclosure generally relates to wireless communications. For example, aspects of the present disclosure relate to reducing vulnerable-road-user (VRU)-messaging overhead and VRU-information-presentation complexity.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is fifth generation (5G) New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in vehicle-to-everything (V2X), vehicle-to-vehicle (V2V), car-to-cloud (C2C), and/or device-to-device (D2D) communication.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for wireless communication. In some aspects, the systems and techniques described herein relate to a method for wireless communication, the method including: receiving, at a server, a vulnerable-road-user (VRU) report from a VRU user equipment (UE), the VRU report including information associated with at least one of a location of the VRU UE, a speed of the VRU UE, or a heading of the VRU UE; determining, based on the VRU report, VRU context information associated with the VRU UE; determining, based on the VRU context information, an updated VRU-message reporting frequency for the VRU UE; and transmitting, to the UE, information indicating the updated VRU-message reporting frequency.

In some aspects, the systems and techniques described herein relate to a method for wireless communication, the method including: determining, at a vulnerable road user (VRU) user equipment (UE), VRU context information associated with the VRU UE; determining, based on the VRU context information, an updated VRU-message reporting frequency for the VRU UE; and transmitting, to a server, a VRU report according to the updated VRU-message reporting frequency, the VRU report including information associated with at least one of a location of the VRU UE, a speed of the VRU UE, or a heading of the VRU UE.

In some aspects, the systems and techniques described herein relate to a method for wireless communication, the method including: receiving, at a server, a vehicle report from a vehicle, the vehicle report including information associated with at least one of a location of the vehicle, a speed of the vehicle, a heading of the vehicle; determining vehicle context information associated with the vehicle based on the vehicle report; determining, based on the vehicle context information, an updated vehicle-message reporting frequency for the vehicle; and transmitting, to the vehicle, information indicating the updated vehicle-message reporting frequency.

In some aspects, the systems and techniques described herein relate to a method for wireless communication, the method including: determining, at a vehicle, vehicle context information associated with the vehicle; determining, based on the vehicle context information, an updated vehicle-message reporting frequency for the vehicle; and transmitting, to a server, a vehicle report according to the updated vehicle-message reporting frequency, the vehicle report including information associated with at least one of a location of the vehicle, a speed of the vehicle, a heading of the vehicle.

In some aspects, the systems and techniques described herein relate to a method for wireless communication, the method including: receiving, at a server, a vehicle report from a vehicle, the vehicle report including information associated with at least one of a location of the vehicle, a speed of the vehicle, a heading of the vehicle; determining, based on the vehicle report, a region of interest (ROI) of the vehicle; receiving a plurality of vulnerable-road-user (VRU) reports from a plurality of respective VRU user equipments (UEs); determining relevant VRU UEs from among the plurality of VRU UEs based on the ROI of the vehicle and the plurality of VRU reports; and transmitting, to the vehicle, VRU information based on relevant VRU reports of the relevant VRU UEs.

In some aspects, the systems and techniques described herein relate to a method for displaying information, the method including: receiving, at a vehicle, vulnerable-road-user (VRU) information including a plurality of locations of a plurality of respective VRU user equipments (UEs); determining a region of interest (ROI) of the vehicle based on at least one of a location of the vehicle, a speed of the vehicle or a heading of the vehicle; determining relevant VRU UEs from among the plurality of VRU UEs based on the ROI of the vehicle and the plurality of locations; and displaying information based on positions of the relevant VRU UEs.

In some aspects, the systems and techniques described herein relate to a method for wireless communication, the method including: determining, at a vehicle, a region of interest (ROI) of the vehicle based on at least one of a location of the vehicle, a speed of the vehicle or a heading of the vehicle; transmitting, from the vehicle to a server, the ROI; receiving, from the server, VRU information based on relevant vulnerable-road-users (VRUs), the relevant VRUs determined based on the ROI.

In some aspects, the systems and techniques described herein relate to a method for wireless communication, the method including: receiving, at a server from a vehicle, a vehicle ROI, the vehicle ROI based on at least one of a location of the vehicle, a speed of the vehicle, a heading of the vehicle; receiving a plurality of vulnerable-road-user (VRU) reports from a plurality of respective VRU user equipments (UEs); determining relevant VRU UEs from among the plurality of VRU UEs based on the vehicle ROI and the plurality of VRU reports; and transmitting, to the vehicle, VRU information based on relevant VRU reports of the relevant VRU UEs.

In some aspects, the systems and techniques described herein relate to an apparatus for wireless communication, the apparatus including: at least one memory; and at least one processor coupled to the at least one memory and configured to: receive, at a server, a vulnerable-road-user (VRU) report from a VRU user equipment (UE), the VRU report including information associated with at least one of a location of the VRU UE, a speed of the VRU UE, or a heading of the VRU UE; determine, based on the VRU report, VRU context information associated with the VRU UE; determine, based on the VRU context information, an updated VRU-message reporting frequency for the VRU UE; and cause at least one transmitter to transmit, to the UE, information indicating the updated VRU-message reporting frequency.

In some aspects, the systems and techniques described herein relate to an apparatus for wireless communication, the apparatus including: at least one memory; and at least one processor coupled to the at least one memory and configured to: determine, at a vulnerable road user (VRU) user equipment (UE), VRU context information associated with the VRU UE; determine, based on the VRU context information, an updated VRU-message reporting frequency for the VRU UE; and cause at least one transmitter to transmit, to a server, a VRU report according to the updated VRU-message reporting frequency, the VRU report including information associated with at least one of a location of the VRU UE, a speed of the VRU UE, or a heading of the VRU UE.

In some aspects, the systems and techniques described herein relate to an apparatus for wireless communication, the apparatus including: at least one memory; and at least one processor coupled to the at least one memory and configured to: receive, at a server, a vehicle report from a vehicle, the vehicle report including information associated with at least one of a location of the vehicle, a speed of the vehicle, a heading of the vehicle; determine vehicle context information associated with the vehicle based on the vehicle report; determine, based on the vehicle context information, an updated vehicle-message reporting frequency for the vehicle; and cause at least one transmitter to transmit, to the vehicle, information indicating the updated vehicle-message reporting frequency.

In some aspects, the systems and techniques described herein relate to an apparatus for wireless communication, the apparatus including: at least one memory; and at least one processor coupled to the at least one memory and configured to: determine, at a vehicle, vehicle context information associated with the vehicle; determine, based on the vehicle context information, an updated vehicle-message reporting frequency for the vehicle; and cause at least one transmitter to transmit, to a server, a vehicle report according to the updated vehicle-message reporting frequency, the vehicle report including information associated with at least one of a location of the vehicle, a speed of the vehicle, a heading of the vehicle.

In some aspects, the systems and techniques described herein relate to an apparatus for wireless communication, the apparatus including: at least one memory; and at least one processor coupled to the at least one memory and configured to: receive, at a server, a vehicle report from a vehicle, the vehicle report including information associated with at least one of a location of the vehicle, a speed of the vehicle, a heading of the vehicle; determine, based on the vehicle report, a region of interest (ROI) of the vehicle; receive a plurality of vulnerable-road-user (VRU) reports from a plurality of respective VRU user equipments (UEs); determine relevant VRU UEs from among the plurality of VRU UEs based on the ROI of the vehicle and the plurality of VRU reports; and cause at least one transmitter to transmit, to the vehicle, VRU information based on relevant VRU reports of the relevant VRU UEs.

In some aspects, the systems and techniques described herein relate to an apparatus for displaying information, the apparatus including: at least one memory; and at least one processor coupled to the at least one memory and configured to: receive, at a vehicle, vulnerable-road-user (VRU) information including a plurality of locations of a plurality of respective VRU user equipments (UEs); determine a region of interest (ROI) of the vehicle based on at least one of a location of the vehicle, a speed of the vehicle or a heading of the vehicle; determine relevant VRU UEs from among the plurality of VRU UEs based on the ROI of the vehicle and the plurality of locations; and display information based on positions of the relevant VRU UEs.

In some aspects, the systems and techniques described herein relate to an apparatus for wireless communication, the apparatus including: at least one memory; and at least one processor coupled to the at least one memory and configured to: determine, at a vehicle, a region of interest (ROI) of the vehicle based on at least one of a location of the vehicle, a speed of the vehicle or a heading of the vehicle; cause at least one transmitter to transmit, from the vehicle to a server, the ROI; receive, from the server, VRU information based on relevant vulnerable-road-users (VRUs), the relevant VRUs determined based on the ROI.

In some aspects, the systems and techniques described herein relate to an apparatus for wireless communication, the apparatus including: at least one memory; and at least one processor coupled to the at least one memory and configured to: receive, at a server from a vehicle, a vehicle ROI, the vehicle ROI based on at least one of a location of the vehicle, a speed of the vehicle, a heading of the vehicle; receive a plurality of vulnerable-road-user (VRU) reports from a plurality of respective VRU user equipments (UEs); determine relevant VRU UEs from among the plurality of VRU UEs based on the vehicle ROI and the plurality of VRU reports; and cause at least one transmitter to transmit, to the vehicle, VRU information based on relevant VRU reports of the relevant VRU UEs.

In some aspects, the apparatus is, or is part of, a vehicle (e.g., an automobile, truck, etc., or a component or system of an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIG. 2 is a diagram illustrating an example of a disaggregated base station architecture, which may be employed by the disclosed systems and methods for a robust and enhanced detection of position overlap (PO) of vehicles, in accordance with some aspects of the present disclosure.

FIG. 3 is a diagram illustrating an example of various user equipment (UEs) communicating over direct communication interfaces (e.g., a cellular based PC5 sidelink interface, 802.11p defined DSRC interface, or other direct interface) and wide area network (Uu) interfaces, in accordance with some aspects of the present disclosure.

FIG. 4 is a block diagram illustrating an example of a computing system of a vehicle, in accordance with some aspects of the present disclosure.

FIG. 5 is a block diagram illustrating an example of a computing system of a user device, in accordance with some aspects of the present disclosure.

FIG. 6 is a diagram illustrating an example of devices involved in wireless communications (e.g., sidelink communications), in accordance with some aspects of the present disclosure.

FIG. 7 is a diagram illustrating an example of a system for sensor sharing (which may alternatively be referred to as “collective perception”) in wireless communications (e.g., C-V2X communications), in accordance with some aspects of the present disclosure.

FIG. 8 is a block diagram illustrating an example system for providing for communications, according to various aspects of the present disclosure;

FIG. 9 includes an illustration of a map of an environment including vehicles and VRUs to illustrate various aspects of the present disclosure;

FIG. 10 includes an example process diagram illustrating a process for communicating, according to various aspects of the present disclosure, and an example flowchart illustrating an example implementation of process, according to various aspects of the present disclosure;

FIG. 11 includes an example process diagram illustrating a process for communicating, according to various aspects of the present disclosure, and an example flowchart illustrating an example implementation of process, according to various aspects of the present disclosure;

FIG. 12 includes an illustration of a map of an environment including a vehicle and VRUs to illustrate various aspects of the present disclosure;

FIG. 13 includes an illustration of a map of an environment including a vehicle and VRUs to illustrate various aspects of the present disclosure;

FIG. 14 is a flow diagram illustrating another example process for wireless communication, in accordance with aspects of the present disclosure;

FIG. 15 is a flow diagram illustrating another example process for wireless communication, in accordance with aspects of the present disclosure;

FIG. 16 is a flow diagram illustrating another example process for wireless communication, in accordance with aspects of the present disclosure;

FIG. 17 is a flow diagram illustrating another example process for wireless communication, in accordance with aspects of the present disclosure;

FIG. 18 is a flow diagram illustrating another example process for wireless communication, in accordance with aspects of the present disclosure;

FIG. 19 is a flow diagram illustrating another example process for displaying information, in accordance with aspects of the present disclosure;

FIG. 20 is a flow diagram illustrating another example process for wireless communication, in accordance with aspects of the present disclosure;

FIG. 21 is a flow diagram illustrating another example process for wireless communication, in accordance with aspects of the present disclosure;

FIG. 22 is a block diagram illustrating an example computing-device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of devices or systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V21), car-to-cloud (C2C), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources including personal device of pedestrians and roadside units, such as traffic cameras) through wireless links to allow the information to be communicated to other vehicles, pedestrians, and/or traffic infrastructure. The information may be transmitted using one or more vehicle-based messages, such as C-V2X messages, which can include Sensor Data Sharing Messages (SDSMs) (e.g., defined by Society of Automotive Engineers (SAE) Standard Document J3224) used by vehicles or other devices to share sensor information, Basic Safety Messages (BSMs) (e.g., defined by SAE J2735) used by vehicles or other devices to share safety-based messages, Cooperative Awareness Messages (CAMs) (e.g., defined by European Telecommunications Standards Institute (ETSI) European Standard (EN) 302 637-2) used by vehicles or other devices to share safety-based messages, Collective Perception Messages (CPMs) (e.g., defined by ETSI Technical Report (TR) 103 562 V2.1.1) used by vehicles or other devices to share safety-based messages, Decentralized Environmental Messages (DENM) (e.g., as defined by ETSI TR 102 698), messages according to SAE J2945/1 and/or ETSI EN 103 300, messages defined by China Society of Automotive Engineers (CSAE) and/or China Intelligent Transportation Systems, and/or other types of messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz (GHz) frequency band. Cellular V2X (C-V2X) was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHZ frequency band. Vehicle-based messages, such as BSMs and CAMs, which are application layer messages, are designed to be wirelessly broadcasted over the 802.11p based DSRC interface and the LTE C-V2X sidelink PC5 interface.

Some vehicle-to-pedestrian (V2P) systems include algorithms to enhance the safety of vulnerable road users (VRUs) by alerting vehicles and/or VRUs. VRUS include road users such as pedestrians and bicyclists. An alert may be based on detecting the possibility of collision between a vehicle and VRU. The possibility of collision may be determined using global navigation satellite system (GNSS) data among other input data points.

To provide such safety for VRUs, VRUs may carry or wear a user equipment (UE) (e.g., a smart phone, smart watch, smart glasses, etc.) that may transmit regular reports including location information, motion information, and/or other information associated with the VRU (e.g., a location of the VRU, a heading of the VRU, and a speed of the VRU). The UE may transmit the reports at a particular frequency, such as at a frequency of 1 Hertz (Hz). Similarly, vehicles may report location information, motion information, and/or other information associated with the vehicles (e.g., a location of the vehicle, a heading of the vehicle, and a speed of the vehicle) at a particular frequency, such as at a frequency of 10 Hz.

A cloud device (e.g., a server in communication with the vehicle) may provide information regarding the VRUs (e.g., locations of the VRUs, headings of the VRUs, speeds of the VRUs, etc.) to vehicles. For example, the cloud device may respond to reports of a vehicle with information related to VRUs. In some aspects, the cloud device may send information related to the VRUs to vehicles at a particular frequency, such as the same frequency at which the vehicles send reports (e.g., 10 Hz) or another frequency.

A vehicle that receives the information about the VRUs (e.g., from the cloud device) may present information regarding the VRUs to a driver of the vehicle, present conditional alerts to the driver regarding the VRUs, track the VRUs, plan a path of the vehicle relative to the VRUs, control the vehicle to avoid the VRUs (e.g., brake the vehicle or turn the vehicle).

Such a safety scheme may involve significant message overhead. For example, in a given environment (e.g., a city or several city blocks) there may be many vehicles and many VRUs. A report (e.g., a VRU report from a VRU to a cloud device or a vehicle report from a vehicle to the cloud device) may include 450 bytes, for example. Thus each VRU in the environment may transmit 450-byte messages every second and each vehicle in the environment may transmit 10 450-byte messages every second. Further, the cloud device may transmit a response (e.g., including VRU information, such as a summary of the VRU reports) to each vehicles within the environment 10 times every second. This may involve significant amount of network traffic.

Further such a safety scheme may place significant burden on the cloud service. For example, the cloud service may be tasked with receiving and relaying VRU information from many VRUs to many vehicles. As an example, a VRU information summary from a cloud service to a vehicle that summarizes 10 VRU reports may be 4000 bytes in size. As the number of vehicles and VRUs in an environment increases (for example, to the size of a few city blocks) the burden of relaying such information may be significant.

Further still, a vehicle receiving VRU information from a cloud service may receive more information than can be processed by a driver. For example, a vehicle may receive information about every VRU in a city (or a few city blocks). If the vehicle presents that information to a driver (e.g., using a map, a heads-up display, etc.), the information may overwhelm the driver and/or not be useful to the driver.

In some aspects of the present disclosure, systems, apparatuses, methods (also referred to as processes), and computer-readable media (collectively referred to herein as “systems and techniques”) are described herein for reducing VRU message overhead and presentation complexity. The systems and techniques may be used in V2X networks, C2C networks, Uu (cellular) networks, and/or may apply to sidelink or other communications. According to a first aspect, the systems and techniques may adjust the rate at which VRUs and/or vehicles transmit reports. For example, based several factors, the systems and techniques may determine a frequency at which a particular vehicle or VRU should send its reports. Thereafter, the vehicle or VRU may transmit reports at the determined frequency. The determined frequency may be less than a default frequency and may thereby reduce message overhead. The frequency may be determined dynamically and may be adjusted over time to maintain safety while reducing message overhead.

According to a second aspect, the systems and techniques (e.g., a cloud service) may determine which VRUs are relevant to a vehicle and transmit information about the relevant VRUs to the vehicle. Further the systems and techniques may refrain from transmitting to the vehicle information regarding VRUs that are irrelevant to the vehicle. By not transmitting information regarding irrelevant VRUs, the systems and techniques may reduce communication burdens of the cloud service.

According to a third aspect, the systems and techniques may determine (e.g., at a vehicle) which VRUs are relevant to the vehicle and present information (e.g., using a map, a heads-up display, etc.) regarding relevant VRUs to a driver of the vehicle. For example, the vehicle may receive a report from a cloud service. The report may include information regarding many VRUs. The vehicle may filter the report to determine which of the VRUs are relevant to the vehicle and present information regarding the relevant VRUs to the driver of the vehicle. Further, the vehicle may refrain from presenting information to the driver regarding VRUs that are irrelevant to the vehicle. By not presenting information regarding irrelevant VRUS to the driver, the systems and techniques may allow the driver to focus on relevant information and not be overwhelmed or distracted by irrelevant information.

The first, second and third aspects may operate together, or in any combination. For example, according to the first aspect, an example system may reduce the reporting frequency of VRUs that are not on or proximate to a road (for example, from a default of 1 Hz to 0.1 Hz). Reducing the reporting frequency may reduce network traffic and conserve resources of the VRUs, the vehicles, and/or the cloud service.

Further, according to the second aspect, a cloud service may receive a report from a vehicle. The cloud service may determine a region of interest (ROI) around the vehicle (based on the location in the report from the vehicle). The cloud service may determine which VRUs (of all the VRUs sending reports to the cloud service) are within the ROI and are thus relevant to the vehicle. The cloud service may send information regarding the relevant VRUs (e.g., a summary of the reports of the relevant VRUs) to the vehicle. By sending information regarding relevant VRUs (and not irrelevant VRUs) the cloud service may conserve resources.

Further, according to the third aspect, the vehicle may determine which of the relevant VRUs of the information received from the cloud service are particularly of interest to the driver. For example, the vehicle may determine a ROI of the vehicle. The ROI determined by the vehicle may be smaller than the ROI determined by the cloud service (e.g., based on the vehicle having more information regarding a planned path of the vehicle). For example, a Vehicle Alert System may perform a fine-grain analysis to further filter the VRUs and identify the specific VRUs that present a risk of a crash. The vehicle may present information to a driver of the vehicle regarding the particularly relevant VRUs while refraining from presenting information regarding other VRUs. By presenting information regarding only VRUs that are particularly relevant (e.g., the present a risk of collision) the vehicle may allow the driver to focus on the most important VRUs while ignoring other VRUs.

Additionally or alternatively, in some aspects, the vehicle can determine its immediate and expected ROI and provide the determined and/or expected ROI to the cloud service. For example, the vehicle may have accurate information regarding the speed, heading, and/or destination of the vehicle, and information regarding maneuvers required to reach the destination. Based on such information, the vehicle may determine an immediate and/or expected ROI and provide the immediate and/or expected ROI to the cloud service.

Further, in some aspects, the vehicle may also be provisioned (or have downloaded) detailed maps. As such, the vehicle can indicate to the server the vehicle's immediate/current ROI and/or the vehicle's expected ROI (e.g, a moving, time-stamped window with associated ROI).

The vehicle may provide the immediate and/or expected ROI in addition to, or as an alternative to, the vehicle providing a vehicle report including motion-state information (e.g., location, speed, heading) of the vehicle.

Further, in some aspects, the vehicle may have more detailed information regarding vehicle characteristics which might affect actions needed to avoid VRUs (brake status, tire wear, etc.). Additionally or alternatively, the vehicle may identify the driver (e.g., based on a paired key fob, phone, internal camera, etc.). Further, the vehicle may have information (e.g., a drive profile) that may indicate driver characteristics (e.g., describing the driver as conservative or aggressive). The vehicle may determine the immediate and/or expected ROI based on the vehicle characteristics and/or the driver characteristics.

In some aspects, the cloud service may receive an immediate and/or expected ROI from a vehicle and, according to the second aspect, determine relevant VRUs for the vehicle based on the immediate and/or expected ROI. The cloud service may provide VRU information based on the relevant VRUs to the vehicle.

In some aspects, according to the third aspect, the vehicle may determine information to display to a driver of a vehicle based on immediate and/or expected ROI. For example, the vehicle may filter relevant VRUs on driver and/or vehicle characteristics.

It may be useful for driving systems (e.g., autonomous, semi-autonomous, or assisted driving systems, such as an advanced driver assistance system (ADAS)) of vehicles to have VRU information. These capabilities may become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may provide VRU information to a driver.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short-Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, VRU UEs such as pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs (also referred to herein as VRU UEs), and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

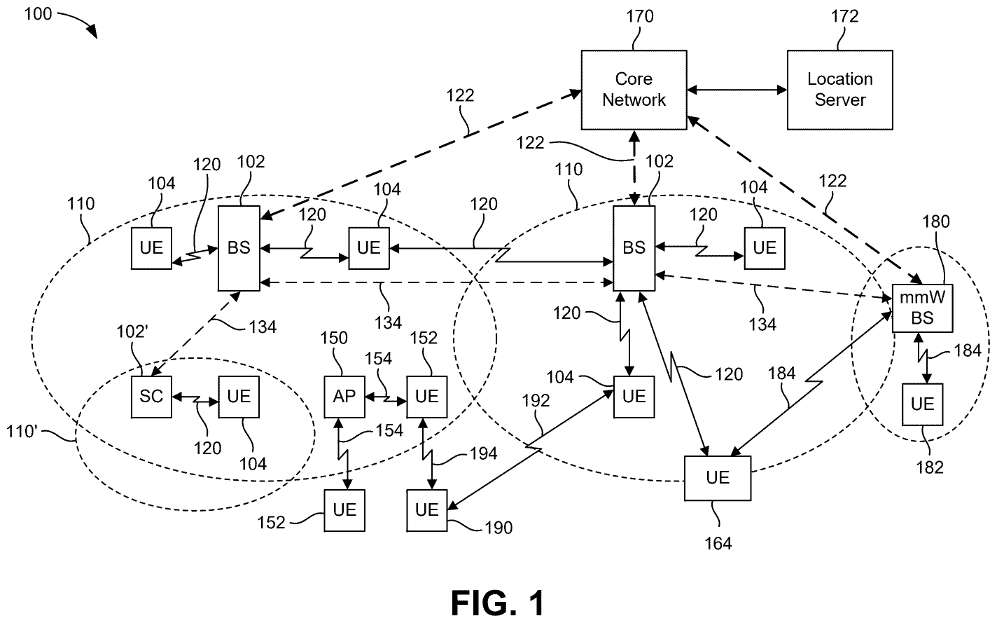

FIG. 1 illustrates an exemplary wireless communications system 100, according to various aspects. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (cMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHZ) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

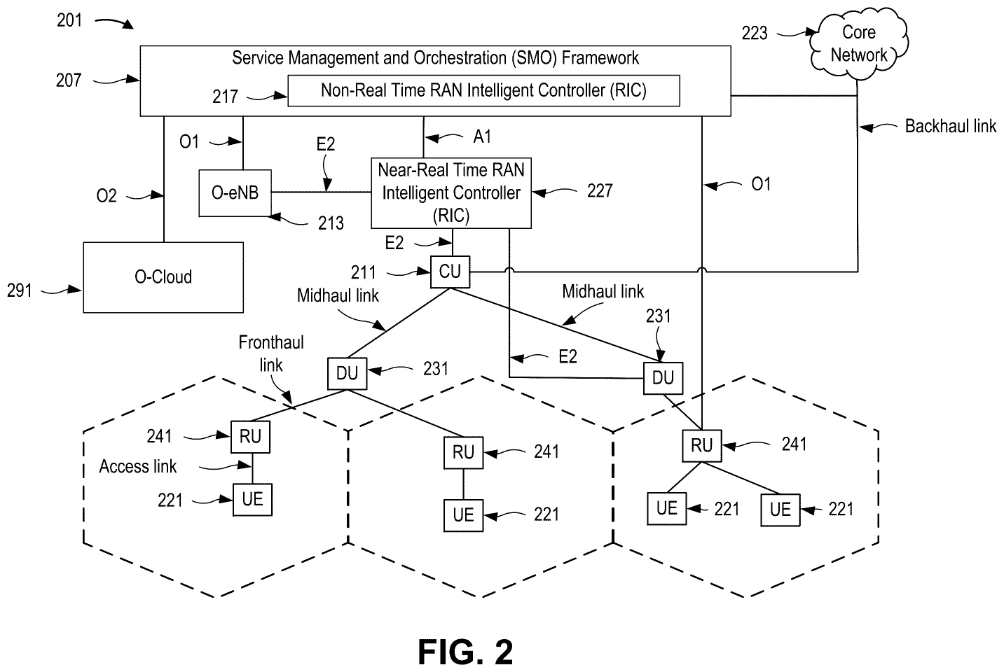

FIG. 2 is a diagram illustrating an example of a disaggregated base station architecture, which may be employed by the disclosed systems and methods for a robust and enhanced detection of position overlap of vehicles, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUs) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the El interface when implemented in an O-RAN configuration. The CU 211 can be implemented to communicate with the DU 231, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (IFFT), digital beamforming, physical random-access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-NB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via O1) or via creation of RAN management policies (such as A1 policies).

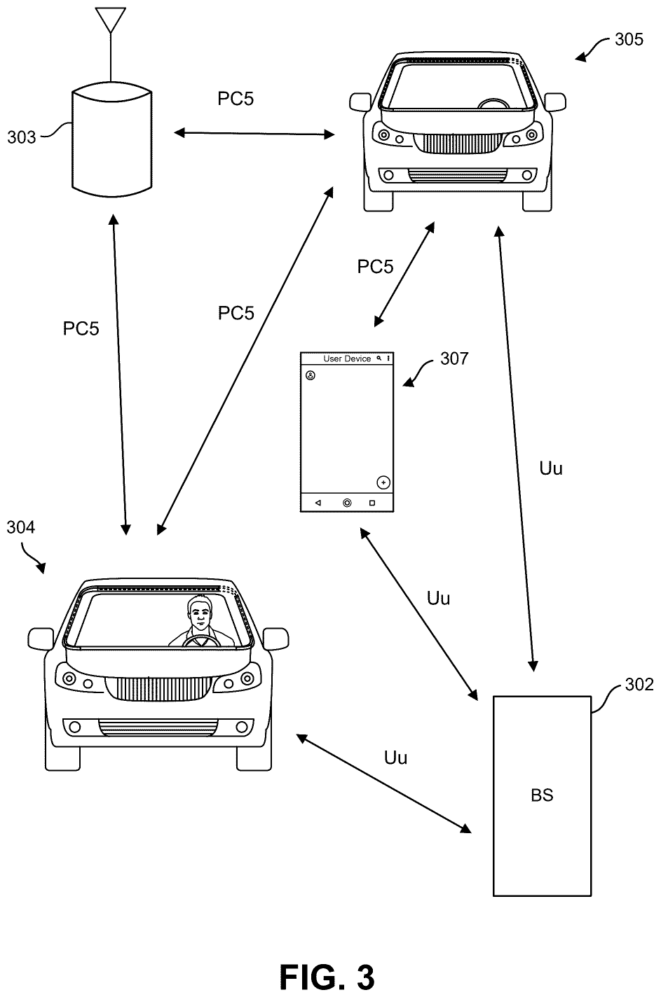

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 communicating with the base station 302 using a network (Uu) interface. In one illustrative example, the user device 307 can communicate with vehicles (e.g., vehicle 305 and/or vehicle 305) over a PC5 interface (or other device-to-device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

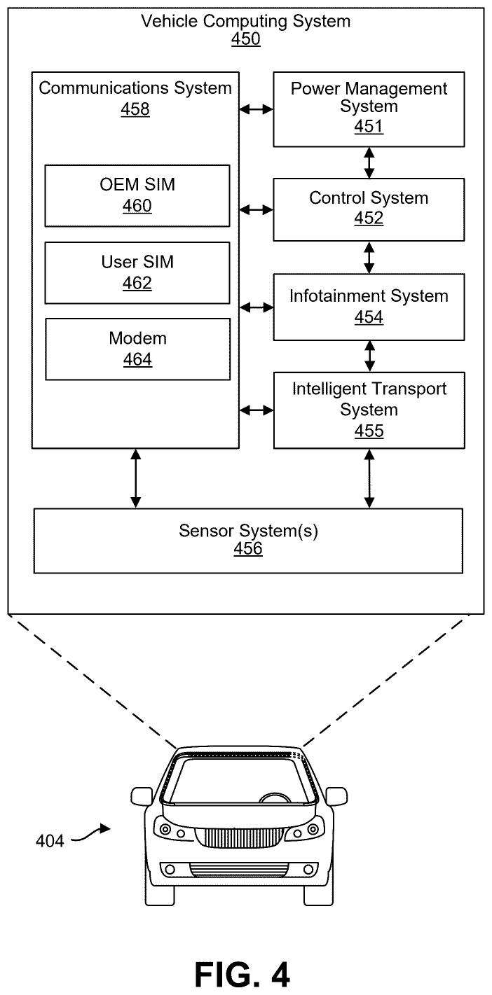

FIG. 4 is a block diagram illustrating an example a vehicle computing system 450 of a vehicle 404. The vehicle 404 is an example of a UE that can communicate with a network (e.g., an eNB, a gNB, a positioning beacon, a location measurement unit, and/or other network entity) over a Uu interface and with other UEs using V2X communications over a PC5 interface (or other device-to-device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (eCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFi™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V21 communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 can determine a lane-change condition has been met that is associated with a message to be sent to other vehicles that are nearby the vehicle in the adjacent lane. The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, SAE J2945/1, European Telecommunications Standards Institute (ETSI) European Standard (EN) 302 637-2, ETSI 103 562 V2.1.1, ETSI TR 102 698, ETSI EN 103 300, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, pedestrian user devices or VRU UEs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown). In some implementations, the vehicle computing system 450 can also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

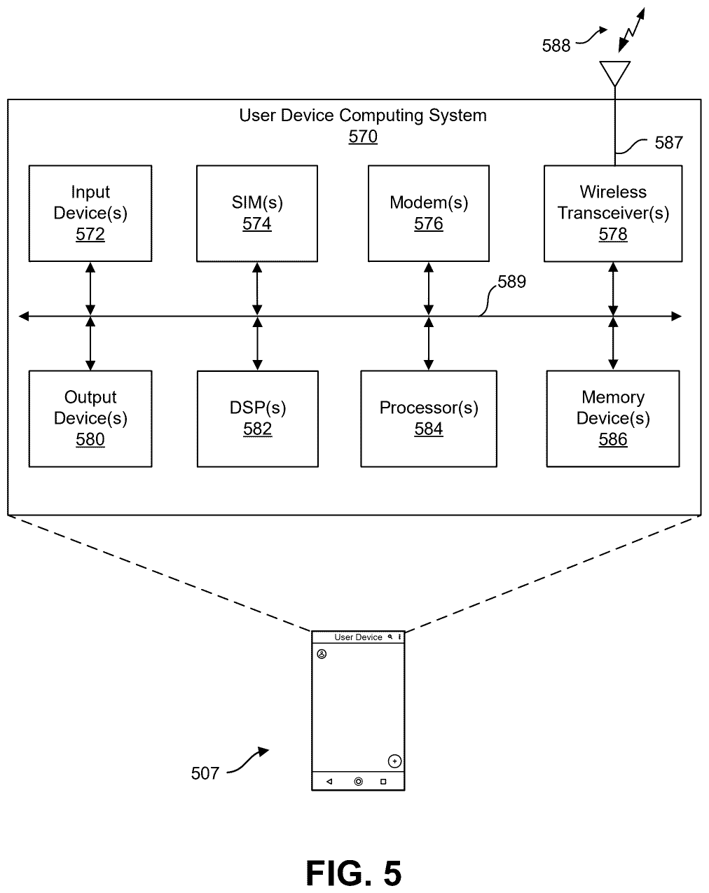

FIG. 5 illustrates an example of a computing system 570 of a user device 507. The user device 507 is an example of a UE that can be used by an end-user. For example, the user device 507 can include a mobile phone, router, tablet computer, laptop computer, tracking device, wearable device (e.g., a smart watch, glasses, an XR device, etc.), Internet of Things (IoT) device, and/or other device used by a user to communicate over a wireless communications network. The computing system 570 includes software and hardware components that can be electrically or communicatively coupled via a bus 589 (or may otherwise be in communication, as appropriate). For example, the computing system 570 includes one or more processors 584. The one or more processors 584 can include one or more CPUs, ASICS, FPGAs, Aps, GPUs, VPUs, NSPs, microcontrollers, dedicated hardware, any combination thereof, and/or other processing device or system. The bus 589 can be used by the one or more processors 584 to communicate between cores and/or with the one or more memory devices 586.

The computing system 570 may also include one or more memory devices 586, one or more digital signal processors (DSPs) 582, one or more SIMs 574, one or more modems 576, one or more wireless transceivers 578, an antenna 587, one or more input devices 572 (e.g., a camera, a mouse, a keyboard, a touch sensitive screen, a touch pad, a keypad, a microphone, and/or the like), and one or more output devices 580 (e.g., a display, a speaker, a printer, and/or the like).

The one or more wireless transceivers 578 can receive wireless signals (e.g., signal 588) via antenna 587 from one or more other devices, such as other user devices, vehicles (e.g., vehicle 404 of FIG. 4 described above), network devices (e.g., base stations such as eNBs and/or gNBs, WiFi routers, etc.), cloud networks, and/or the like. In some examples, the computing system 570 can include multiple antennae. The wireless signal 588 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 578 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 588 into a baseband or intermediate frequency and can convert the RF signals to the digital domain.

In some cases, the computing system 570 can include a coding-decoding device (or CODEC) configured to encode and/or decode data transmitted and/or received using the one or more wireless transceivers 578. In some cases, the computing system 570 can include an encryption-decryption device or component configured to encrypt and/or decrypt data (e.g., according to the AES and/or DES standard) transmitted and/or received by the one or more wireless transceivers 578.

The one or more SIMs 574 can each securely store an IMSI number and related key assigned to the user of the user device 507. As noted above, the IMSI and key can be used to identify and authenticate the subscriber when accessing a network provided by a network service provider or operator associated with the one or more SIMs 574. The one or more modems 576 can modulate one or more signals to encode information for transmission using the one or more wireless transceivers 578. The one or more modems 576 can also demodulate signals received by the one or more wireless transceivers 578 in order to decode the transmitted information. In some examples, the one or more modems 576 can include a 4G (or LTE) modem, a 5G (or NR) modem, a modem configured for V2X communications, and/or other types of modems. The one or more modems 576 and the one or more wireless transceivers 578 can be used for communicating data for the one or more SIMs 574.

The computing system 570 can also include (and/or be in communication with) one or more non-transitory machine-readable storage media or storage devices (e.g., one or more memory devices 586), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 586 and executed by the one or more processor(s) 584 and/or the one or more DSPs 582. The computing system 570 can also include software elements (e.g., located within the one or more memory devices 586), including, for example, an operating system, device drivers, executable libraries, and/or other code, such as one or more application programs, which may comprise computer programs implementing the functions provided by various aspects, and/or may be designed to implement methods and/or configure systems, as described herein.

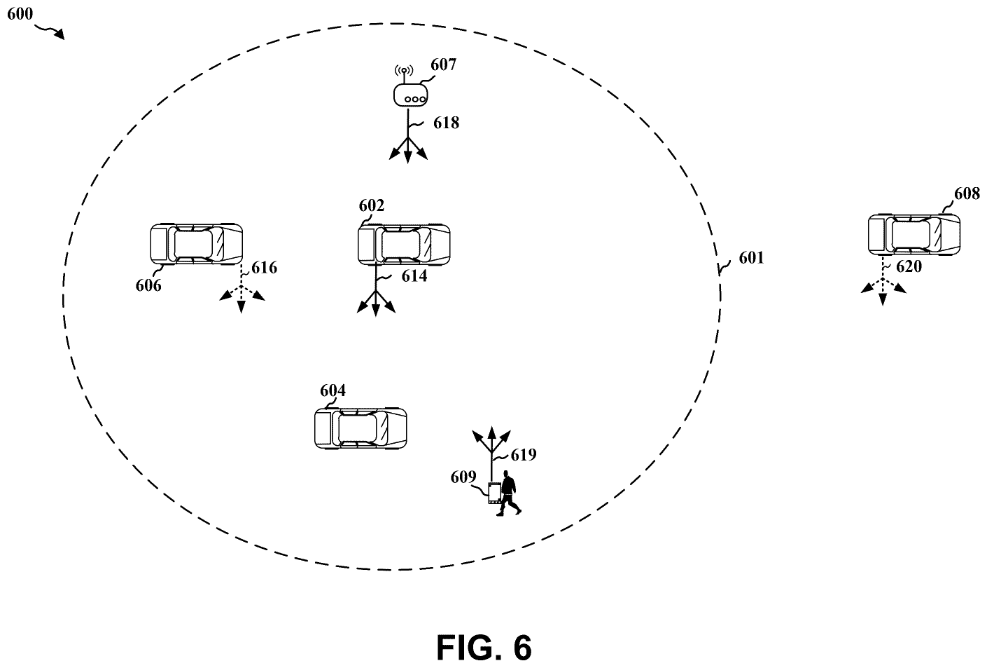

FIG. 6 illustrates an example 600 of wireless communication between devices based on sidelink communication, such as V2X or other D2D communication. The communication may be based on a slot structure. For example, transmitting UE 602 may transmit a transmission 614, e.g., comprising a control channel and/or a corresponding data channel, which may be received by UEs 604, 606, 607, 608 and/or 609. At least one UE may comprise an autonomous vehicle or an unmanned aerial vehicle. A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. The UEs 602, 604, 606, 608, and/or 609 may each be capable of operating as a transmitting device in addition to operating as a receiving device. Thus, UEs 606, 607, 608 and 609 are illustrated as transmitting transmissions 616, 618, 620, and 619 respectively. The transmissions 614, 616, 619, and 620 may be broadcast or multicast to nearby devices. For example, UE 602 may transmit communication intended for receipt by other UEs within a range 601 of UE 602. Additionally or alternatively, RSU 607 may receive communication from and/or transmit transmissions 618 to UEs 602, 604, 606, 608 and/or 609. UE 602, 604, 606, 607, 608, and/or 609 may comprise respective detection components. UE 602, 604, 606, 607, 608, and/or 609 may also comprise a BSM or mitigation component.

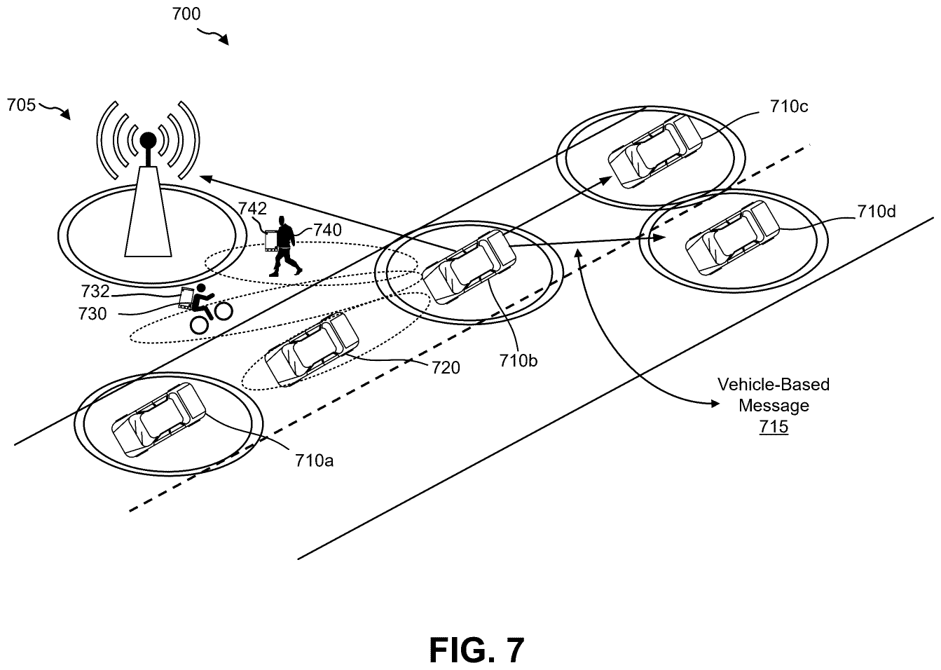

FIG. 7 is a diagram illustrating an example of a system 700 for sensor sharing (which may alternatively be referred to as “collective perception”) in wireless communications (e.g., C-V2X communications), in accordance with some aspects of the present disclosure. In FIG. 7, the system 700 is shown to include a plurality of equipped (e.g., V2X capable) network devices. The plurality of equipped network devices includes vehicles (e.g., automobiles) 710a, 710b, 710c, 710d, an RSU 705, a VRU UE 732 of a cyclist 730 and VRU UE 742 of a pedestrian 740. Also shown are a plurality of non-equipped devices, which include a non-equipped vehicle 720. The system 700 may comprise more or fewer equipped network devices and/or more or fewer non-equipped network devices, than as shown in FIG. 7. In addition, the system 700 may comprise more or fewer different types of equipped network devices (e.g., which may include equipped UEs) and/or more or fewer different types of non-equipped network devices (e.g., which may include non-equipped UEs) than as shown in FIG. 7. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices (e.g., vehicles 710a, 710b, 710c, 710d, RSU 705, VRU UE 732, and/or VRU UE 742) may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In addition, at least some of the equipped network devices may be configured to perform sidelink positioning (e.g., as described by 3rd Generation partnership project (3GPP) Release 18) to determine absolute location, relative location, and/or motion states of surrounding UEs. In one or more examples, vehicles 710a, 710b, 710c, 710d RSU 705, VRU UE 732, and/or VRU UE 742 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 700. For example, vehicle 710b may be a luxury vehicle and, as such, have more expensive, higher capability sensors than other vehicles that are economy vehicles. In one illustrative example, vehicle 710b may have one or more higher capability LIDAR sensors (e.g., high capability optical lasers and optical sensors) than the other equipped network devices in the system 700. In one illustrative example, a LIDAR of vehicle 710b may be able to detect the cyclist 730 and/or a pedestrian 740 with a large degree of confidence (e.g., a seventy percent degree of confidence). In another example, vehicle 710b may have higher capability radar (e.g., high capability RF antennas) than the other equipped network devices in the system 700. For instance, the radar of vehicle 710b may be able to detect the cyclist 730 and/or pedestrian 740 with a degree of confidence (e.g., an eight-five percent degree of confidence). In another example, vehicle 710b may have higher capability camera (e.g., with higher resolution capabilities, higher frame rate capabilities, better lens, etc.) than the other equipped network devices in the system 700.

During operation of the system 700, the equipped network devices (e.g., vehicles 710a, 710b, 710c, 710d RSU 705, VRU UE 732, and/or VRU UE 742) may generate at least one vehicle-based message 715 (e.g., a C-V2X message, such as a Sensor Data Sharing Message (SDSM), a Basic Safety Message (BSM), a Cooperative Awareness Message (CAM), a Collective Perception Messages (CPM), a Decentralized Environmental Message (DENM), and/or other type of message). In some implementations, the vehicle-based message 715 may include a specific use case or safety warning, such as a do-not-pass warning (DNPW) or a forward collision warning (FCW), related to the current conditions of the equipped network device (e.g., vehicles 710a, 710b, 710c, 710d). In some examples, the vehicle-based message 715 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), a Decentralized Environmental Message (DENM), and/or other format.

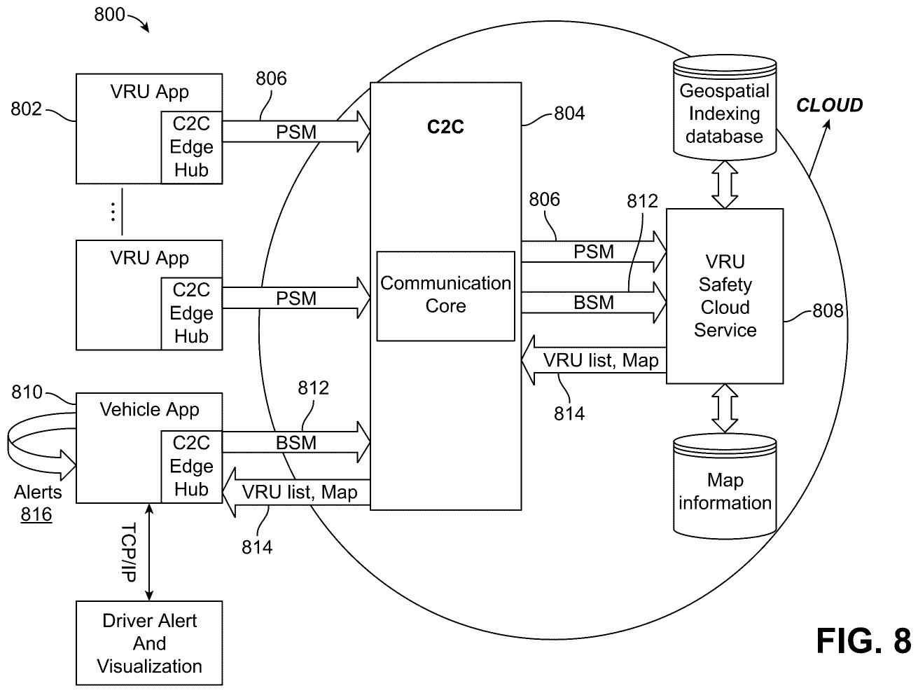

FIG. 8 is a block diagram illustrating an example system 800 for providing for communications, according to various aspects of the present disclosure. System 800 may increase the safety of vulnerable road users (VRUs) by providing information regarding the VRUs to vehicles. System 800 may implement or be implemented in a wireless communication network, such as wireless communications system 100 of FIG. 1.

For example, VRUs may carry or wear respective user equipments (UEs) (such as user device 507 of FIG. 5). In the present disclosure, a UE of a VRU may be referred to as a “VRU UE.” The UEs may run a VRU application (“VRU app 802”). The UEs, running VRU app 802 may participate in a car-to-cloud (C2C) network (“C2C network 804”) as edge devices. VRU apps 802 may send respective VRU reports 806 (e.g., personal safety messages (“PSMs”)) to C2C network 804. The VRU reports may include information regarding a location of the VRU, a speed of the VRU, and/or a heading of the VRU. C2C network 804 may relay VRU reports 806 to a VRU safety cloud service (“cloud service 808”).

Additionally, a vehicle may include a computing system (such as vehicle computing system 450 of FIG. 4). The computing system may run a vehicle application (“vehicle app 810”). The vehicles, running vehicle app 810 may participate in C2C network 804 as edge devices. Vehicle app 810 may send a vehicle report 812 (e.g., a basic safety message (“BSM”)) to C2C network 804. The vehicle reports may include information regarding a location of the vehicle, a speed of the vehicle, and/or a heading of the vehicle. C2C network 804 may relay vehicle report 812 to a cloud service 808.

Cloud service 808 may generate VRU information (e.g., a summary or digest of VRU reports 806 received by cloud service 808) (“VRU list 814”) and transmit VRU list 814 to vehicle app 810 via C2C network 804.

Vehicle app 810 may present information to a driver of the vehicle based on alerts 816. For example, vehicle app 810 may generate alerts 816 based on VRU list 814. Additionally or alternatively, vehicle app 810 may, in some cases, control the vehicle based on VRU list 814. For example, vehicle app 810 may apply brakes, turn the vehicle, and/or plan a path of the vehicle, for example, to avoid collisions with VRUs.

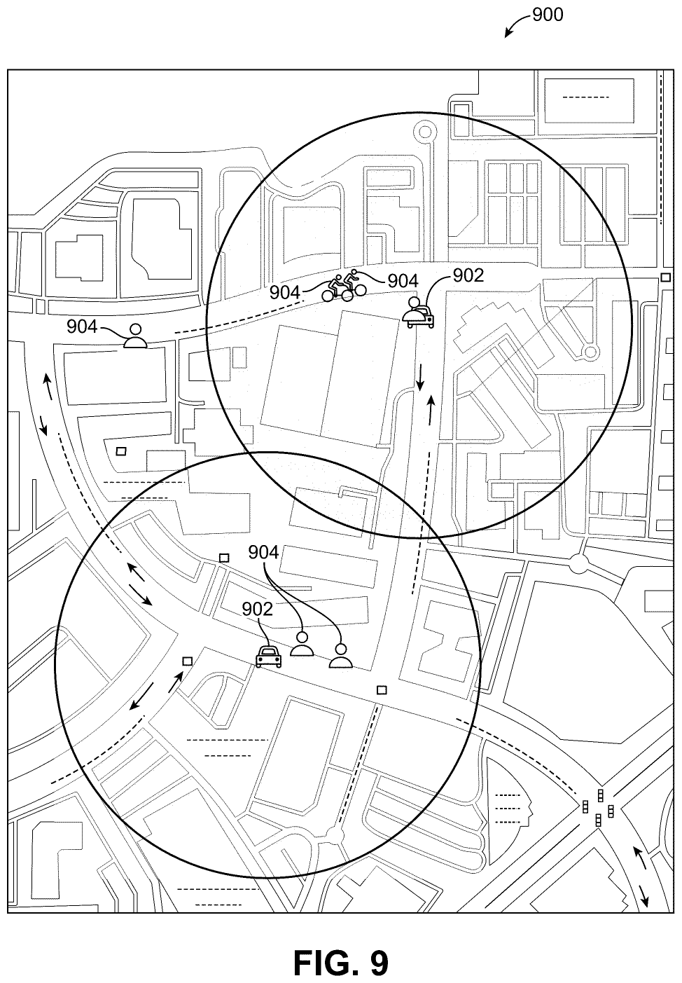

FIG. 9 includes an illustration of a map of an environment 900 including vehicles 902 and VRUs 904. Each of vehicles 902 may run a vehicle app (e.g., vehicle app 810 of FIG. 8) and may send vehicle reports (e.g., vehicle reports 812 of FIG. 8) to a cloud service (e.g, cloud service 808 of FIG. 8). Each of VRUs 904 may carry (or wear) a UE that may run a VRU app (e.g., VRU app 802 of FIG. 8). The VRU app may send VRU reports (e.g., VRU reports 806 of FIG. 8) to the cloud service.

According to a first aspect, VRUs may send reports at a VRU reporting frequency determined based on context information. For example, VRU app 802 (or cloud service 808) may determine contextual information of the UE of VRU app 802. The contextual information may be, or may include, information indicating whether the VRU is on a road, proximate to the road, moving on the road, waiting to cross the road, speeding up, in an environment with low VRU density, travelling in a vehicle, distant from the road, not engaged in a road activity, slowing down, and/or in an environment with high VRU density. VRU app 802 (or cloud service 808) may determine a frequency for VRU app 802 to send VRU reports 806 based on the contextual information.

For example, VRU app 802 (or cloud service 808) may determine to only transmit VRU reports 806 when the VRU of VRU app 802 is engaged in road activities such as walking, biking, waiting for a signal, etc. VRU app 802 (and/or cloud service 808) may use device sensors (e.g, inertial measurement units (IMUs) and/or cameras) and location information (e.g., based on a global navigation satellite system (GNSS)) to determine the activity for the VRU of VRU app 802. VRU app 802 (or cloud service 808) may determine that VRU app 802 is to reduce the frequency of sending VRU reports messages or stop sending VRU report messages when the VRU is engaged in non-road activities. The frequency of the VRU report messages can be further tuned based on information such as speed, location, and environmental inferences from map data, etc.

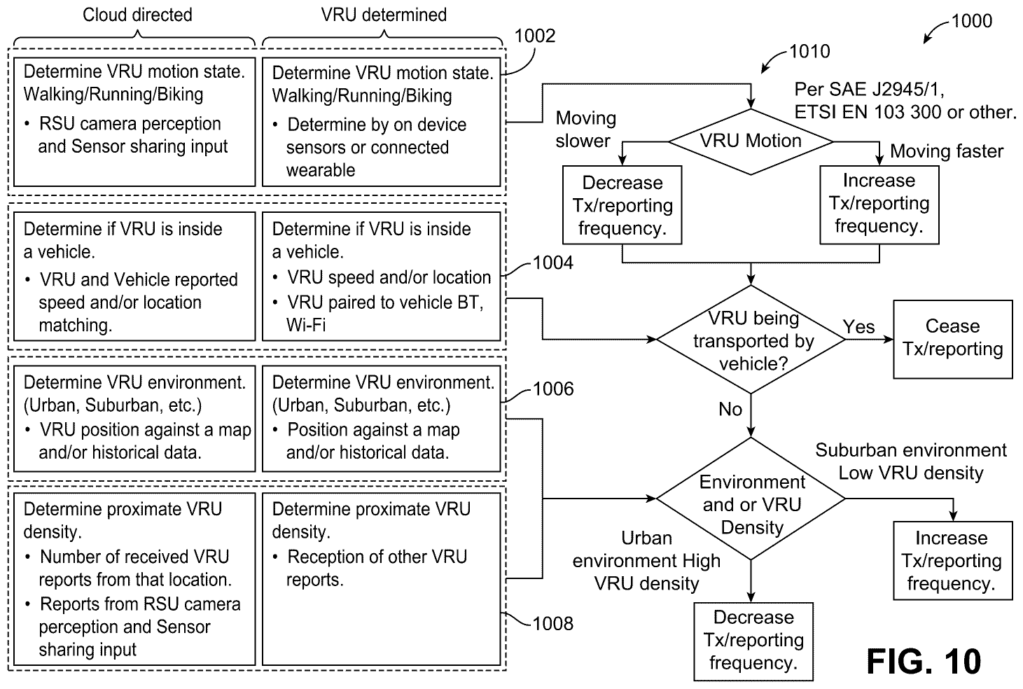

FIG. 10 includes an example process diagram illustrating a process 1000 for communicating, according to various aspects of the present disclosure, and an example flowchart 1010 illustrating an example implementation of process 1000, according to various aspects of the present disclosure. Further, process 1000 includes determining or adjusting a VRU reporting frequency of a VRU.

For example, at a block 1002, a motion state of a VRU (e.g., one of VRUs 904 of FIG. 9) may be determined. For example, a UE of the VRU (e.g., running VRU app 802 of FIG. 8) may determine a motion state of the VRU based on sensors of the UE (e.g., an IMU, or a camera) and/or location information (e.g., determined using GNSS data).

As another example, a cloud service (e.g., cloud service 808 of FIG. 8) may determine the motion state of the VRU, for example, based on VRU reports from the UE. Additionally or alternatively, in some aspects, the cloud service may receive images of the VRU, e.g., from cameras in the environment, such as cameras of roadside units (RSUs), vehicles, and/or other VRUs, for example, according to a sensor-sharing scheme.

Based on the motion state information, a VRU reporting frequency may be determined or adjusted. For example, based on the VRU moving below a threshold speed, the VRU reporting frequency may be decreased. For instance, if a pedestrian stops, the pedestrian may be at less risk of colliding with a vehicle. Accordingly, the UE of the pedestrian may report less frequently to conserve power and communication bandwidth. Alternatively, if the pedestrian begins running, the pedestrian may be at a higher risk of colliding with a vehicle. Accordingly the UE of the pedestrian may report more frequently so vehicles in the environment can be apprised of the VRU's location regularly. In the present disclosure, a decrease in a frequency of a recurrence of an event (e.g., transmitting a report) may include decreasing the frequency to zero, for example, ceasing the recurrence of the event.

As another example, at block 1004, a determination may be made regarding whether the VRU is inside a vehicle. For example, the UE and/or the cloud service may determine whether the VRU is inside a vehicle based on a speed and/or location of the UE. For example, if the speed of the VRU exceeds a threshold, the UE and/or the cloud service may determine that the VRU is moving inside a vehicle. As another example, the UE may determine that the VRU is inside a vehicle based on the UE connecting (e.g., according to, for example, a Bluetooth™ protocol or an institute of electronics and electrical engineers (IEEE) 802.11 protocol) with the vehicle.

In some aspects, if the UE (or the cloud service) determines that the VRU is inside a vehicle, the UE (or the cloud service) may reduce the VRU reporting frequency (e.g., to 0.01 Hz or 0 Hz—such as a cessation in reporting). In some aspects, the UE (or the cloud) may determine to reduce the VRU reporting frequency if the vehicle that the VRU is in is reporting to the cloud service.

As another example, at block 1006, a determination may be made regarding the environment of the VRU. For example, the environment of the VRU may be classified into classes such as, urban, suburban, rural, tunnel, canyon, mountain, low-visibility environment, etc. The UE (or the cloud service) may make the determination about the environment based on the location of the UE, a map of the environment, time of day information, and/or weather information.

In some aspects, the UE (or the cloud service) may determine the VRU reporting frequency based on the classification of the environment. For example, if the VRU is in a rural environment, or a low-visibility environment, the UE (or the cloud service) may determine a relatively high VRU reporting frequency (e.g., 2, 5, or 10 Hz). Such a determination may be based on the increased benefit of alerting a driver to VRUs in an environment where the driver may not expect or be able to easily see VRUs. In contrast, if the VRU is in an urban environment, the UE (or the cloud service) may determine a relatively low VRU reporting frequency (e.g., 0.1, 0.5., or 1 Hz). Such a determination may be based on an expectation that a driver is alert and aware of the likelihood of VRUs in the urban environment.

As another example, at block 1008, a determination may be made regarding VRU density (e.g., a number of VRUs in the environment) or proximate VRU density (e.g., a number of VRUs proximate to the VRU of the UE). The UE of the VRU may determine the VRU density (or proximate VRU density) based on receiving reports from other VRUs. The cloud service may determine the VRU density (or proximate VRU density) based on a number of VRU reports from the location of the VRU or based on reports (or images) from other devices in the environment (e.g., vehicles, RSUs, etc.) according to a sensor-sharing scheme.

In some aspects, the UE (or the cloud service) may determine the VRU reporting frequency based on the VRU density (or proximate VRU density). For example, the if the VRU is in a dense VRU environment, the UE (or the cloud service) may determine a relatively low VRU reporting frequency. Such a determination may be based on an expectation that a driver is alert and aware of the likelihood of VRUs based on the VRU density in the environment and/or based on an expectation that others of the VRUs proximate to the VRU are also sending reports. Alternatively, if the VRU is in a low-VRU-density environment, the UE (or the cloud service) may determine a relatively high VRU reporting frequency. Such a determination may be based on an expectation that a driver may not be expecting VRUs and/or based on an expectation that there are no other VRUs in the immediate proximity reporting their presence.

Additionally or alternatively, the VRU reporting frequency may be determined based on a communication protocol and/or bandwidth used to transmit and/or receive the VRU reports. For example, some communication protocols may be “heavy” and others “light.” For instance, heavy protocols may require more power and/or time to communicate than light protocols. Further in some situations, some communication channels according to some communication protocols and/or bandwidths may be experiencing greater traffic conditions (e.g., network congestion) than other communication protocols. Process 1000 may determine to modify the VRU reporting frequency based, at least in part, on the communication protocol and/or bandwidth used to transmit the VRU reports. For example, a VRU may transmit VRU reports to a cloud service using a wireless cellular (Uu) link. At an example time, the cellular network may be congested. Process 1000 may determine to reduce the VRU reporting frequency based on the congestion.

In some aspects, determinations regarding the VRU reporting frequency may be made and implemented at the UE of the VRU. In some aspects, determinations regarding the VRU reporting frequency may be made at the cloud service. The cloud service may then instruct the UE of the VRU to report according to the VRU reporting frequency. In some aspects, determinations regarding the VRU reporting frequency may be made at both the UE and the cloud service. For example, the UE may have more recent location information than the cloud service and may make preliminary determinations regarding the VRU reporting frequency. Further, the cloud service may receive reports from the UE and make further determinations regarding the VRU reporting frequency and instruct the UE accordingly.

In some aspects, the blocks of process 1000 of FIG. 10 may be implemented as a flowchart, such as flowchart 1010. Alternatively, the blocks may be used as factors in determining the VRU reporting frequency (e.g., according to a weighted factoring scheme). In some aspects, the UE (or the cloud service) may determine the VRU reporting frequency to be a highest reporting frequency suggested by any of the factors or blocks described herein.

Determining and/or adjusting a VRU reporting frequency according to contextual information of the VRU may conserve computation and communication resources (e.g., power of the UE of the VRU, bandwidth etc.) without significantly impacting safety of the VRU. For example, reducing the VRU reporting frequency may conserve resources. Further, the VRU reporting frequency may be dynamically adjusted as the contextual information of the VRU changes to ensure that the safety of the VRU is not significantly impacted.

Additionally or alternatively, according to the first aspect, vehicles may send reports at a vehicle reporting frequency determined based on context information. For example, vehicle app 810 (or cloud service 808) may determine contextual information of a vehicle of vehicle app 810. The contextual information may be, or may include, a speed of the vehicle, an environment classification of a road (e.g, whether the road is in an urban environment, a suburban environment, a rural environment, a tunnel, a low-visibility environment, etc.), and/or a visibility condition relative to the road (e.g., based on weather, time of day, and/or the natural occlusions in the environment itself, such as tight buildings and/or trees). Vehicle app 810 (or cloud service 808) may determine a frequency for vehicle app 810 to send vehicle reports 812 based on the contextual information. Vehicles can also tune the frequency based on whether the vehicle is being driven, speed of the vehicle, type of road environment inferred from location, external information such as weather conditions, etc.

Process 1000 may be cloud directed or VRU determined. For example, in a cloud-directed example, cloud service 808 may determine the reporting frequency (e.g., based on block 1002, block 1004, block 1006 and/or block 1008) and send an updated reporting frequency to VRU app 802. VRU app 802 may apply the updated reporting frequency and send reports to cloud service 808 according to the updated reporting frequency. Alternatively, in a VRU-determined example, VRU app 802 may determine and apply the updated reporting frequency (e.g., based on block 1002, block 1004, block 1006 and/or block 1008). Accordingly, VRU app 802 may send reports to cloud service 808 according to the updated reporting frequency.

In some aspects, cloud service 808 may determine a reporting frequency and send an indication of the reporting frequency to VRU app 802. In some cases, VRU app 802 may determine to report according to the indicated reporting frequency. In some aspects, VRU app 802 may determine its own reporting frequency independent of (e.g., in the absence of) a reporting frequency from cloud service 808. In other cases, VRU app 802 may determine its own reporting frequency and determine to not report according to the reporting frequency indicated by cloud service 808. For example, VRU app 802 may determine to use its own reporting frequency instead of a reporting frequency instructed by cloud service 808 (e.g., based on an assumption that VRU app 802 has more recent data than cloud service 808).

Additionally or alternatively, VRU app 802 may determine an updated reporting frequency based at least partially on an updated reporting frequency received from cloud service 808. For example, VRU app 802 may determine to use a highest-frequency reporting frequency selected from among a reporting frequency indicated by cloud service 808 and a reporting frequency determined by VRU app 802 (e.g., based on an assumption that more frequent reporting is better than less frequent reporting). As another example, VRU app 802 may determine a reporting frequency based on a weighted average of a reporting frequency instructed by cloud service 808 and a reporting frequency determined by VRU app 802.

VRU app 802 may determine its reporting frequency based on environmental conditions (e.g., lighting, weather, visibility, etc.), VRU app 802 may determine a higher reporting frequency if conditions are non-ideal (e.g., if visibility is low, for example, based on lighting and/or weather conditions).

Additionally or alternatively, VRU app 802 may determine its reporting frequency based on activity data (e.g., indicative that a user of VRU app 802 is walking on the sidewalk versus stopped, participating in “road” activity versus not, walking speed, etc.). VRU app 802 may determine to reduce the reporting frequency or cease reporting if the user is not actively participating in a “road” activity. Alternatively, VRU app 802 may determine to increase the reporting frequency if the user is determined to be walking at a speed above a threshold, etc.

Additionally or alternatively, VRU app 802 may determine its reporting frequency based on a mobility type of the VRU. For example, VRU app 802 may determine a mobility type associated with the VRU (e.g., based on a speed and/or maneuverability of VRU). For instance, VRU app 802 may determine its reporting frequency based on whether VRU app 802 determines that a user of the VRU is walking, running, on a bike, a scooter, etc.

Additionally or alternatively, VRU app 802 may determine its reporting frequency based on the VRU's expected movement pattern. For example, VRU app 802 may track a movement pattern of the VRU over time and determine an expected movement pattern of the VRU. For instance, VRU app 802 may determine its reporting frequency based on whether the movement pattern is expected to be erratic or steady.

The VRU's mobility type and/or movement patterns may be included in safety parameters that may set in the VRU device. For example, the mobility type and/or movement pattern may be based on or parameters set in the VRU device indicating that the VRU is a child, elderly, blind etc. Additionally or alternatively, the mobility type and/or movement pattern may be based on the VRU's expected destination or point of interest along the way (e.g., if VRU is trying to catch a bus across the street).

Additionally or alternatively, VRU app 802 may determine its reporting frequency based on perceived location accuracy. For example, VRU app 802 may increase its reporting frequency based on a determination regarding GPS accuracy, which may be affected by occlusions (such as buildings) or other factors that could. For instance, VRU app 802 may increase its reporting frequency if location accuracy is poor.

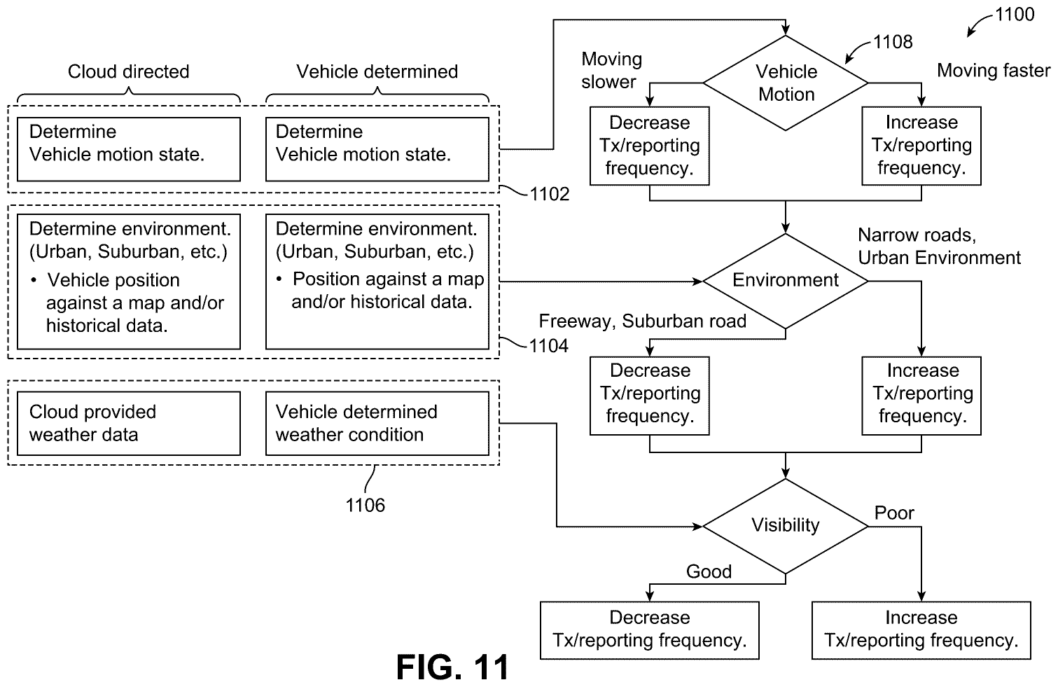

FIG. 11 includes an example process diagram illustrating a process 1100 for communicating, according to various aspects of the present disclosure, and an example flowchart 1108 illustrating an example implementation of process 1100, according to various aspects of the present disclosure. Further, process 1100 includes determining or adjusting a vehicle reporting frequency of a vehicle.

At block 1102, a determination may be made regarding a motion state of a vehicle. For example, the vehicle (or the cloud service) may determine whether the vehicle is moving, how fast the vehicle is moving, parked, waiting at a traffic light, etc. The vehicle may include various control systems and/or sensors that may know the motion state of the vehicle. The server may determine the motion state of the vehicle based on reports from the vehicle and/or based on information from other sensors in the environment (e.g., cameras of other vehicles, RSUs, etc.).

In some aspects, the vehicle (or the cloud service) may determine or adjust the vehicle reporting frequency based on the motion state of the vehicle. For example, the vehicle reporting frequency may be determined according to a speed of the vehicle. For example, there may be a tiered series of thresholds indicating various vehicle reporting frequencies for various speed ranges. For example, if the vehicle is moving above a certain speed (e.g., 40 kilometers per hour (KPH)) the vehicle may report at a rate of 10 Hz. If the vehicle is moving above another speed (e.g., 60 KPH) the vehicle may report at 20 Hz.

As another example, at block 1104, a determination may be made regarding the environment of the vehicle. For example, the environment of the vehicle may be classified into classes such as, urban, suburban, rural, tunnel, canyon, mountain, low-visibility environment, etc. The vehicle (or the cloud service) may make the determination about the environment based on the location of the vehicle and a map of the environment, time of day information.

In some aspects, the vehicle (or the cloud service) may determine the vehicle reporting frequency based on the classification of the environment. For example, if the vehicle is in a rural environment, or a low-visibility environment, the vehicle (or the cloud service) may determine a relatively high vehicle reporting frequency (e.g., 10 Hz, 20 Hz, or 30 Hz). Such a determination may be based on the increased benefit of alerting a driver of the vehicle to VRUs in an environment where the driver may not expect or be able to easily see VRUs. In contrast, if the vehicle is in an urban environment, the vehicle (or the cloud service) may determine a relatively low vehicle reporting frequency (e.g., 10 Hz, 5 Hz, or 1 Hz). Such a determination may be based on an expectation that a driver is alert and aware of the likelihood of VRUs in the urban environment.

As another example, at block 1106, a determination may be made regarding weather and/or visibility conditions. For example, the cloud service may have access to time and weather information for the environment. Additionally or alternatively, the vehicle may have access to time and weather information and/or may have sensors that may make determinations regarding the weather and/or visibility.

In some aspects, the vehicle (or the cloud service) may determine the vehicle reporting frequency based on the weather and/or visibility conditions in the environment. For example, if the vehicle has low visibility or is traveling on slick roads, the vehicle may report frequently, (e.g., 10 Hz, 5 Hz, or 1 Hz) so that the vehicle may receive VRU information from the server frequently and control the vehicle or alert the driver appropriately. Alternatively, if the vehicle has good visibility and is traveling on dry roads, the vehicle may report less frequently than it would be otherwise.

Additionally or alternatively, the vehicle reporting frequency may be determined based on a communication protocol and/or bandwidth used to transmit and/or receive the vehicle reports. Process 1000 may determine to modify the vehicle reporting frequency based, at least in part, on the communication protocol and/or bandwidth used to transmit the vehicle reports. For example, a vehicle may transmit vehicle reports to a cloud service using a wireless cellular (Uu) link. At an example time, the cellular network may be congested. Process 1000 may determine to reduce the vehicle reporting frequency based on the congestion.

In some aspects, determinations regarding the vehicle reporting frequency may be made and implemented at the vehicle. In some aspects, determinations regarding the vehicle reporting frequency may be made at the cloud service. The cloud service may then instruct the vehicle to report according to the vehicle reporting frequency. In some aspects, determinations regarding the vehicle reporting frequency may be made at both the vehicle and the cloud service. For example, the vehicle may have more recent location information than the cloud service and may make preliminary determinations regarding the vehicle reporting frequency. Further, the cloud service may receive reports from the vehicle and make further determinations regarding the vehicle reporting frequency and instruct the vehicle accordingly.

In some aspects, the blocks of process 1100 of FIG. 11 may be implemented as a flowchart, such as flowchart 1108. Alternatively, the blocks may be used as factors in determining the vehicle reporting frequency (e.g., according to a weighted factoring scheme). In some aspects, the vehicle (or the cloud service) may determine the vehicle reporting frequency to be a highest reporting frequency suggested by any of the factors or blocks described herein.

Determining and/or adjusting a vehicle reporting frequency according to contextual information of the vehicle may conserve computation and communication resources (e.g., power of the vehicle, bandwidth etc.) without significantly impacting safety of VRUs. For example, reducing the vehicle reporting frequency may conserve resources. Further, the vehicle reporting frequency may be dynamically adjusted as the contextual information of the vehicle changes to ensure that the safety of VRUs is not significantly impacted. Because the cloud service may be configured to respond to reports of the vehicle with VRU information, adjusting vehicle reporting frequencies may conserve resources of the vehicles, it may also conserve resources of the cloud service.

According to a second aspect, a cloud service may select VRUs to include in VRU information to send to a particular vehicle based on relevance of the selected VRUs to the particular vehicle. For example, the sizes of C2C responses (e.g., VRU list 814) can be improved (e.g., decreased) by filtering out VRUs that are not relevant for a particular vehicle. Such reductions may contribute to reducing the cost of the operation of the cloud service, and/or the amount of cellular coverage needed to support the VRU safety service.

For instance, the cloud service may implement proximity-based filtering to limit the list of VRUs to those within a certain region of interest (RoI) of a particular vehicle. The RoI shape may be globally defined by the cloud service, as a geometric shape around the vehicle (e.g., a circle or hexagon). As an alternative, the shape and/or size may be based on information reported by the vehicle such as speed, location, and environment details that can be inferred from location such as dense-urban, etc. For example, the shape and/or size of the ROI may be determined based on the vehicle context information described above with regard to the first aspect. Additionally, the intent of the driving entity (such as route plan indicating an upcoming turn), can be used as additional input which can be used to the refine the RoI shape.

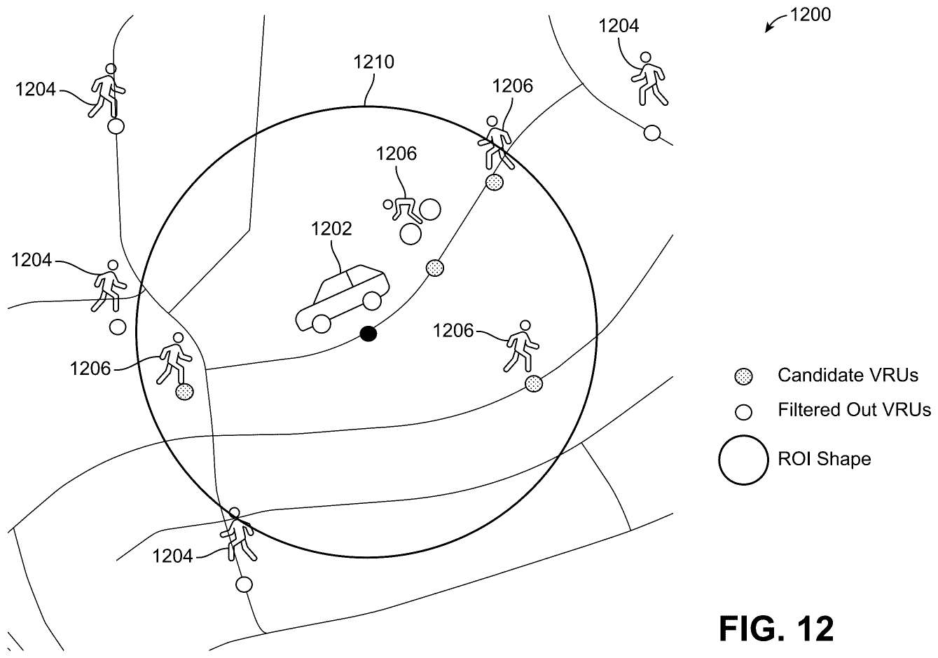

FIG. 12 includes an illustration of a map 1200 of an environment including a vehicle 1202, VRUs 1204, and VRUs 1206 to illustrate various aspects of the present disclosure. Vehicle 1202 may run a vehicle app (e.g., vehicle app 810 of FIG. 8) and may send vehicle reports (e.g., vehicle reports 812 of FIG. 8) to a cloud service (e.g, cloud service 808 of FIG. 8). Each of VRUs 1204 and VRUs 1206 may carry (or wear) a UE that may run a VRU app (e.g., VRU app 802 of FIG. 8). The VRU app may send VRU reports (e.g., VRU reports 806 of FIG. 8) to the cloud service.

In the example illustrated by FIG. 12, vehicle 1202 may send a report to the cloud service. Based on the report (e.g., based on the location in the report) the cloud service may determine ROI 1210 around vehicle 1202. ROI 1210 is illustrated as a circle centered on vehicle 1202. In other cases, the cloud service may determine an ellipse, a triangle, or other shape. The circle, ellipse, triangle, or other shape may not be centered on vehicle 1202 but may be based on the heading and/or speed of vehicle 1202 such that more of the shape is ahead of vehicle 1202 than behind vehicle 1202.

The cloud service may receive reports from a number of UEs of respective VRUs in the environment (including, VRUs 1204 and VRUs 1206). The cloud service may determine which of the VRUs are relevant to vehicle 1202 and which are not based on ROI 1210. For example, the cloud service may determine that VRUs 1206 (which are inside ROI 1210) are relevant to vehicle 1202 and VRUs 1204 (which are not inside ROI 1210) are not relevant to vehicle 1202.

The cloud service may send VRU information to vehicle 1202. The VRU information may be based on reports from VRUs 1206. In some aspects, the VRU information may include a summary or digest of the VRU reports. In other aspects, the VRU information may be the VRU reports. The VRU information may not include information based on VRUs 1204.

By not sending VRU information based on VRUs 1204, the cloud service may conserve resources (e.g., computation and/or communication time and/or power). By sending VRU information based on VRUs 1206, the cloud service may provide vehicle 1202 with relevant safety information to keep VRUs 1206 safe (e.g., not reducing the safety of VRUs 1206 while sending less information).

According to a third aspect, a vehicle may select to present information to a driver regarding relevant VRUs based on relevance of the relevant VRUs to the vehicle. For example, the size of the messages from a vehicle app (e.g., vehicle app 810 of FIG. 8) to the visualization/presentation module of the vehicle control system may be a function of the number of relevant VRUs filtered by the algorithm in the vehicle. For example, the vehicle may refine a list of VRUs (e.g., VRU list 814 of FIG. 8) that are presented to the driver visualization.

The number of VRUs presented to a driver may affect how easy or hard it is for the driver to focus on the VRUs that pose potential risks of collision. To reduce driver-presentation complexity (e.g., the amount of information presented to the driver), the vehicle may implement proximity-based filtering to limit the list of VRUs to those within a certain region of interest (Rol) of the vehicle. The list of VRUs can be refined by the vehicle app to limit the VRUs presented to only include the ones that are of immediate interest to the driving entity (e.g., a human driver or an advanced driver assistance system (ADAS).

The list of VRUs may be refined by a filter that limits the list to VRUs in a shape corresponding to a longer distance ahead of the vehicle and reasonable distance on the other sides, e.g., a rectangle. As an alternative, other shapes that factor in intent of the driving entity such as upcoming turns, etc., and vehicle information such as speed, environmental aspects inferred from location, etc. may be used. The shape and/or size may be based on information reported by the vehicle such as speed, location, and environment details that can be inferred from location such as dense-urban, etc. For example, the shape and/or size of the ROI may be determined based on the vehicle context information described above with regard to the first aspect. Additionally, the intent of the driving entity (such as route plan indicating an upcoming turn), can be used as additional input which can be used to the refine the RoI shape.

Further filtering of VRUs can be based on focusing on VRUs that are in the direction of vehicle motion, both ahead of the vehicle and those approaching the vehicle path from the other directions (including from behind the vehicle). The filtering may allow the vehicle to ignore VRUs moving away from the vehicle and/or other directions.

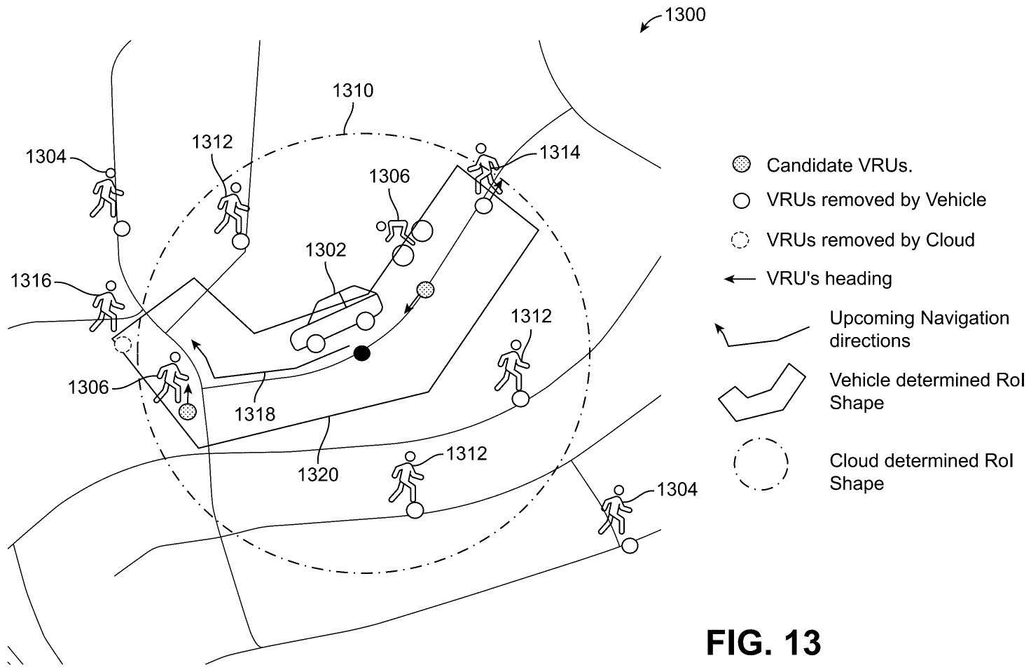

FIG. 13 includes an illustration of a map of an environment 1300 including a vehicle 1302, VRUs 1304, VRUs 1306, VRUs 1312, a VRU 1314, and a VRUs 1316 to illustrate various aspects of the present disclosure. Vehicle 1302 may run a vehicle app (e.g., vehicle app 810 of FIG. 8) and may send vehicle reports (e.g., vehicle reports 812 of FIG. 8) to a cloud service (e.g, cloud service 808 of FIG. 8). Each of VRUs 1304, VRUs 1306, VRUs 1312, VRU 1314, and VRUs 1316 may carry (or wear) a UE that may run a VRU app (e.g., VRU app 802 of FIG. 8). The VRU app may send VRU reports (e.g., VRU reports 806 of FIG. 8) to the cloud service.

In some cases, vehicle 1302 may send a report to the cloud service. Based on the report (e.g., based on the location in the report) the cloud service may determine ROI 1310 around vehicle 1302 (e.g., as described with regard to FIG. 12). The cloud service may receive reports from a number of UEs of respective VRUs in the environment 1300 (including, VRUs 1304, VRUs 1306, VRUs 1312, VRU 1314, and VRUs 1316). The cloud service may determine that VRUs 1306, VRUs 1312, and VRU 1314 are relevant to vehicle 1302 and that VRUs 1304 and VRUs 1316 are not relevant to vehicle 1302. The cloud service may send VRU information to vehicle 1302 based on reports from VRUs 1306, VRUs 1312, and VRU 1314.

In other cases, vehicle 1302 may send a report to the cloud service and the cloud service may respond with a VRU information for all VRUs for which the cloud service has information. For example, the cloud service may receive reports from a number of UEs of respective VRUs in environment 1300 (including VRUs 1304, VRUs 1306, VRUs 1312, VRU 1314 and VRUs 1316. The cloud service may send VRU information to vehicle 1302 based on reports from all of VRUs 1304, VRUs 1306 VRUs 1312, VRU 1314, and VRUs 1316.

In either case, vehicle 1302 may determine a ROI 1320 based on a location of vehicle 1302, a speed of vehicle 1302, a heading of vehicle 1302, a planned path 1318 of vehicle 1302, and/or other contextual information of vehicle 1302 and/or environment 1300. Vehicle 1302 may determine to present information to a driver of vehicle 1302 based on the relevant VRUs, for example, VRUs 1306 that are in ROI 1320.

Because vehicle 1302 determines ROI 1320 to be smaller than ROI 1310, vehicle 1302 may determine to not present information to the driver regarding VRUs 1312, even though vehicle 1302 may have received VRU information based on VRUs 1312. In cases in which the cloud service did not filter the VRUs, vehicle 1302 may present information regarding VRUs 1316 (which would been filtered by the cloud service based on VRUs 1316 being outside ROI 1310, but which would not be filtered by vehicle 1302 based on VRUs 1316 being within ROI 1320).

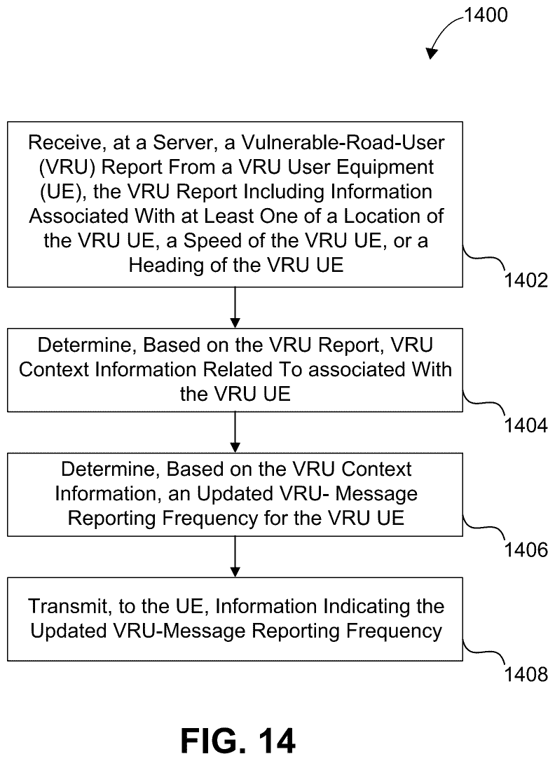

FIG. 14 is a flow diagram illustrating a process 1400 for wireless communication, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1400. The one or more operations of process 1400 may be implemented as software components that are executed and run on one or more processors.

At block 1402, a computing device (or one or more components thereof) may receive, at a server, a vulnerable-road-user (VRU) report from a VRU user equipment (UE), the VRU report including information associated with at least one of a location of the VRU UE, a speed of the VRU UE, or a heading of the VRU UE.

At block 1404, the computing device (or one or more components thereof) may determine, based on the VRU report, VRU context information associated with the VRU UE.

In some aspects, the VRU context information may be, or may include, at least one of: a location of the VRU UE relative to a road; a speed of the VRU UE; an environment classification of the road; or a communication protocol and/or bandwidth used to receive the VRU report.

In some aspects, determining the VRU context information is further based on at least one of: map relative to a road; other VRU reports from other VRUs in an environment; or images of the VRU obtained by a camera in the environment.

In some aspects, the VRU context information comprises an indication that the VRU UE is at least one of: on a road; proximate to the road; moving on the road; immobile at a crosswalk or intersection; speeding up; in an environment with low VRU density; travelling in a vehicle; distant from the road; not engaged in a road activity; slowing down; or in an environment with high VRU density.

At block 1406, the computing device (or one or more components thereof) may determine, based on the VRU context information, an updated VRU-message reporting frequency for the VRU UE.

In some aspects, determining the updated VRU-message reporting frequency may be, or may include, determining an increase in the updated VRU-message reporting frequency for the VRU UE based on a determination that the VRU UE is at least one of: on a road; proximate to the road; moving on the road; waiting to cross the road; speeding up; or in an environment with low VRU density.

In some aspects, determining the updated VRU-message reporting frequency may be, or may include, determining a decrease in a reporting frequency of the VRU UE based on a determination that the VRU UE is at least one of: travelling in a vehicle; distant from a road; not engaged in a road activity; slowing down; or in an environment with high VRU density.

At block 1408, the computing device (or one or more components thereof) may cause at least one transmitter to transmit, to the UE, information indicating the updated VRU-message reporting frequency.

In some aspects, the VRU UE may be configured to transmit further VRU reports to the server at the updated VRU-message reporting frequency based on receiving the updated VRU-message reporting frequency from the server.

In some aspects, a vehicle may display information, control a vehicle, or plan a path for the vehicle, based on the VRU reports.

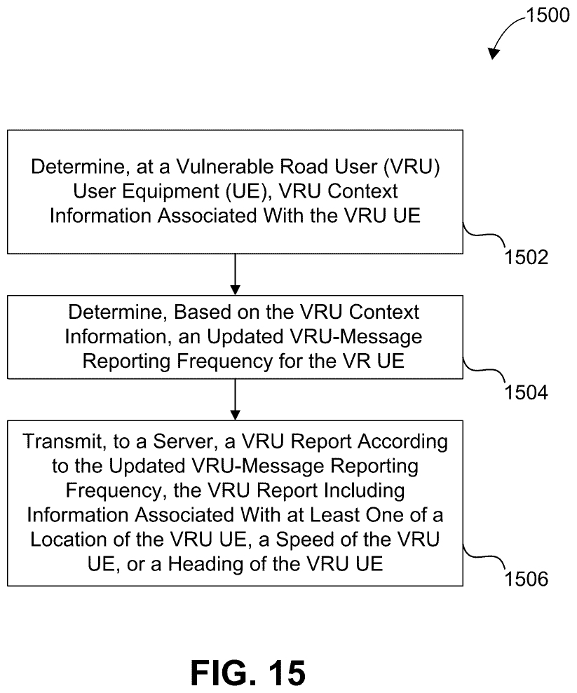

FIG. 15 is a flow diagram illustrating a process 1500 for wireless communication, in accordance with aspects of the present disclosure. One or more operations of process 1500 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1500. The one or more operations of process 1500 may be implemented as software components that are executed and run on one or more processors.

At block 1502, a computing device (or one or more components thereof) may determine, at a vulnerable road user (VRU) user equipment (UE), VRU context information associated with the VRU UE.

In some aspects, the VRU context information may be, or may include, at least one of: a location of the VRU UE relative to a road; a speed of the VRU UE; an environment classification of the road; or a communication protocol and/or bandwidth used to transmit the VRU report.

In some aspects, the VRU context information may be, or may include, an indication that the VRU UE is at least one of: on a road; proximate to the road; moving on the road; immobile at a crosswalk or intersection; speeding up; in an environment with low VRU density; travelling in a vehicle; distant from the road; not engaged in a road activity; slowing down; or in an environment with high VRU density.

At block 1504, the computing device (or one or more components thereof) may determine, based on the VRU context information, an updated VRU-message reporting frequency for the VRU UE.

In some aspects, determining the updated VRU-message reporting frequency may be, or may include, determining an increase in the updated VRU-message reporting frequency for the VRU UE based on a determination that the VRU UE is at least one of: on a road; proximate to the road; moving on the road; waiting to cross the road; speeding up; or in an environment with low VRU density.

In some aspects, wherein determining the updated VRU-message reporting frequency may be, or may include, determining a decrease in a reporting frequency of the VRU UE based on a determination that the VRU UE is at least one of: travelling in a vehicle; distant from a road; not engaged in a road activity; slowing down; or in an environment with high VRU density.

At block 1506, the computing device (or one or more components thereof) may cause at least one transmitter to transmit, to a server, a VRU report according to the updated VRU-message reporting frequency, the VRU report including information associated with at least one of a location of the VRU UE, a speed of the VRU UE, or a heading of the VRU UE.

In some aspects, a vehicle may display information, control a vehicle, or plan a path for the vehicle, based on the VRU reports.

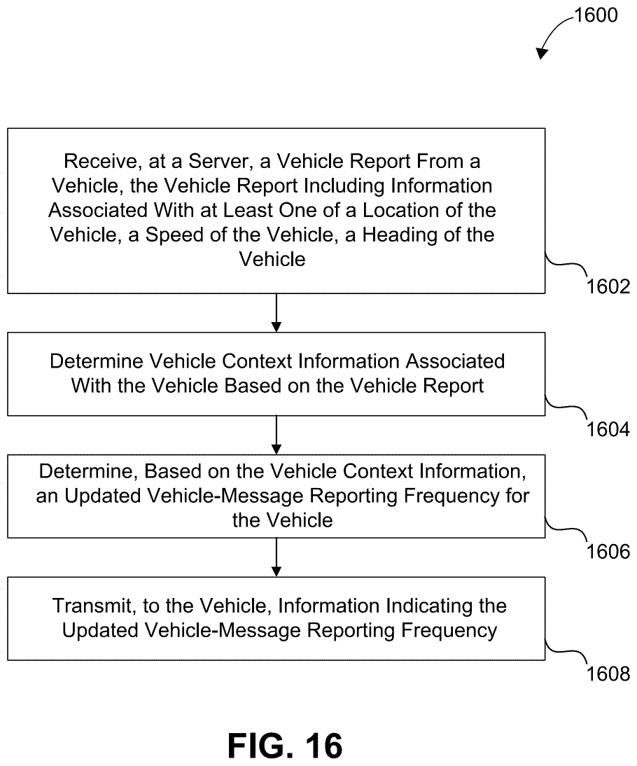

FIG. 16 is a flow diagram illustrating a process 1600 for wireless communication, in accordance with aspects of the present disclosure. One or more operations of process 1600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1600. The one or more operations of process 1600 may be implemented as software components that are executed and run on one or more processors.

At block 1602, a computing device (or one or more components thereof) may receive, at a server, a vehicle report from a vehicle, the vehicle report including information associated with at least one of a location of the vehicle, a speed of the vehicle, a heading of the vehicle.

At block 1604, the computing device (or one or more components thereof) may determine vehicle context information associated with the vehicle based on the vehicle report.

In some aspects, the vehicle context information may be, or may include, at least one of: a speed of the vehicle; an environment classification of a road; a visibility condition relative to the road; or a communication protocol and/or bandwidth used to receive the vehicle report.

In some aspects, the vehicle context information may be further based on at least one of: map relative to a road; or weather data.

In some aspects, the vehicle context information may be, or may include, an indication that the vehicle is at least one of: speeding up; in an environment with low vulnerable road user (VRU) density; in an urban environment; not moving; slowing down; in an environment with high VRU density; or in a suburban environment.

At block 1606, the computing device (or one or more components thereof) may determine, based on the vehicle context information, an updated vehicle-message reporting frequency for the vehicle.

In some aspects, determining the updated vehicle-message reporting frequency may be, or may include, determining an increase in the updated vehicle-message reporting frequency for the vehicle based on a determination that the vehicle is at least one of: speeding up; in an environment with low vulnerable road user (VRU) density; or in an urban environment.

In some aspects, determining the updated vehicle-message reporting frequency may be, or may include, determining a decrease in the updated vehicle-message reporting frequency for the vehicle based on a determination that the vehicle is at least one of: not moving; slowing down; in an environment with high VRU density; or in a suburban environment.

At block 1608, the computing device (or one or more components thereof) may cause at least one transmitter to transmit, to the vehicle, information indicating the updated vehicle-message reporting frequency.

In some aspects, the vehicle may be configured to transmit further vehicle reports to the server at the updated vehicle-message reporting frequency based on receiving information indicating the updated vehicle-message reporting frequency from the server.

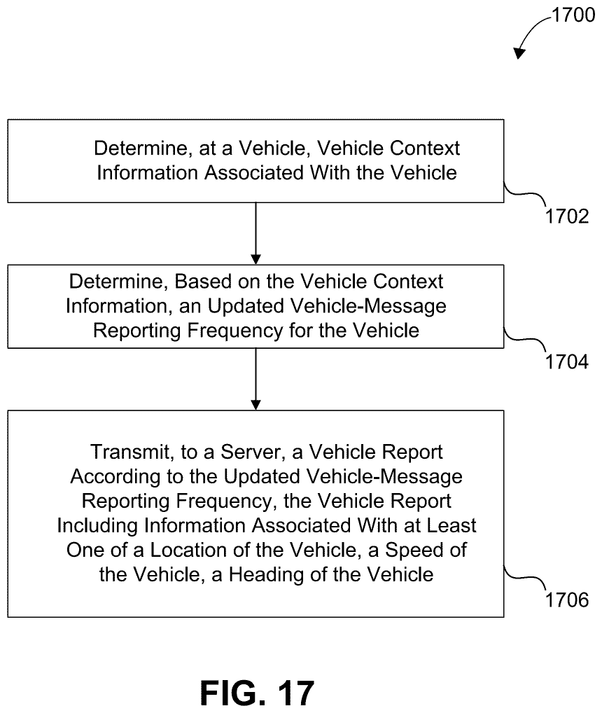

FIG. 17 is a flow diagram illustrating a process 1700 for wireless communication, in accordance with aspects of the present disclosure. One or more operations of process 1700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1700. The one or more operations of process 1700 may be implemented as software components that are executed and run on one or more processors.

At block 1702, a computing device (or one or more components thereof) may determine, at a vehicle, vehicle context information associated with the vehicle.

In some aspects, the vehicle context information may be, or may include, at least one of: a speed of the vehicle; an environment classification of a road; a visibility condition relative to the road; or a communication protocol and/or bandwidth used to transmit the vehicle report.

In some aspects, the vehicle context information may be further based on at least one of: map relative to a road; or weather data.

In some aspects, the vehicle context information may be, or may include, an indication that the vehicle is at least one of: speeding up; in an environment with low vulnerable road user (VRU) density; in an urban environment; not moving; slowing down; in an environment with high VRU density; or in a suburban environment.

At block 1704, the computing device (or one or more components thereof) may determine, based on the vehicle context information, an updated vehicle-message reporting frequency for the vehicle.

In some aspects, determining the updated vehicle-message reporting frequency may be, or may include, determining an increase in the updated vehicle-message reporting frequency for the vehicle based on a determination that the vehicle is at least one of: speeding up; in an environment with low vulnerable road user (VRU) density; or in an urban environment.

In some aspects, determining the updated vehicle-message reporting frequency may be, or may include, determining a decrease in the updated vehicle-message reporting frequency for the vehicle based on a determination that the vehicle is at least one of: not moving; slowing down; in an environment with high VRU density; or in a suburban environment.

At block 1706, the computing device (or one or more components thereof) may cause at least one transmitter to transmit, to a server, a vehicle report according to the updated vehicle-message reporting frequency, the vehicle report including information associated with at least one of a location of the vehicle, a speed of the vehicle, a heading of the vehicle,

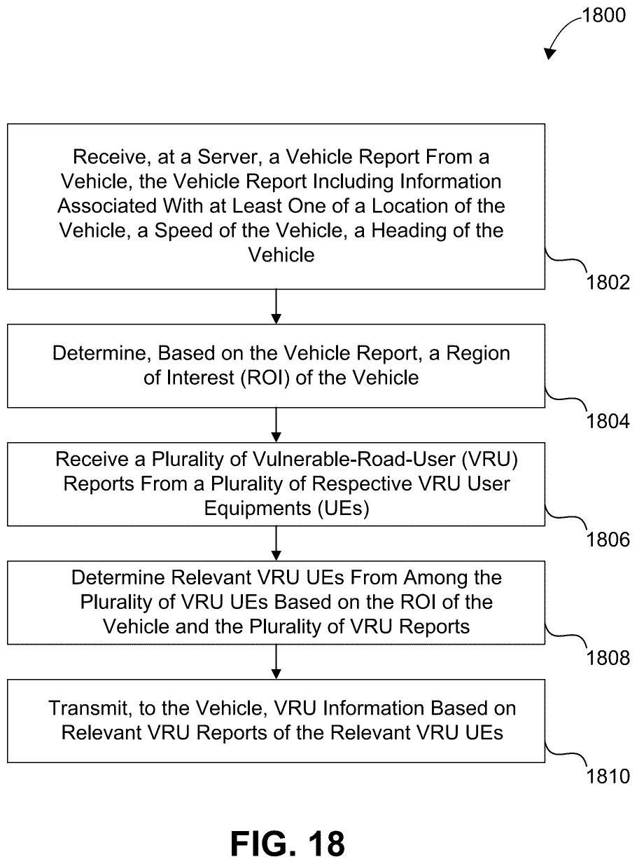

FIG. 18 is a flow diagram illustrating a process 1800 for wireless communication, in accordance with aspects of the present disclosure. One or more operations of process 1800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1800. The one or more operations of process 1800 may be implemented as software components that are executed and run on one or more processors.

At block 1802, a computing device (or one or more components thereof) may receive, at a server, a vehicle report from a vehicle, the vehicle report including information associated with at least one of a location of the vehicle, a speed of the vehicle, a heading of the vehicle.

At block 1804, the computing device (or one or more components thereof) may determine, based on the vehicle report, a region of interest (ROI) of the vehicle.

In some aspects, the ROI of the vehicle may be, or may include, a geometric shape around the vehicle.

In some aspects, the ROI of the vehicle may be, or may include, a geometric shape around the vehicle and the geometric shape is not centered on the vehicle based on the heading of the vehicle.

In some aspects, the ROI of the vehicle may be, or may include, a geometric shape around the vehicle and wherein a size of the geometric shape is based on the speed of the vehicle.

In some aspects, the ROI is shaped and sized based on at least one of: the speed of the vehicle; the heading of the vehicle; a planned path of the vehicle; an environment classification of a road on which the vehicle is traveling; a visibility condition relative to the road; vehicle characteristics; or driver characteristics.

At block 1806, the computing device (or one or more components thereof) may receive a plurality of vulnerable-road-user (VRU) reports from a plurality of respective VRU user equipments (UEs).

At block 1808, the computing device (or one or more components thereof) may determine relevant VRU UEs from among the plurality of VRU UEs based on the ROI of the vehicle and the plurality of VRU reports.

At block 1810, the computing device (or one or more components thereof) may cause at least one transmitter to transmit, to the vehicle, VRU information based on relevant VRU reports of the relevant VRU UEs.

In some aspects, a vehicle may display information, control a vehicle, or plan a path for the vehicle, based on the VRU information.

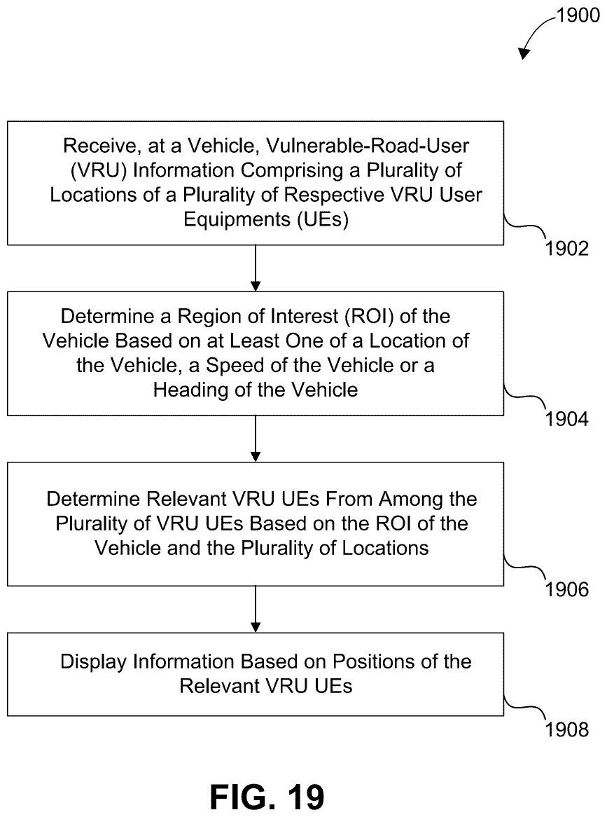

FIG. 19 is a flow diagram illustrating a process 1900 for displaying information, in accordance with aspects of the present disclosure. One or more operations of process 1900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1900. The one or more operations of process 1900 may be implemented as software components that are executed and run on one or more processors.

At block 1902, a computing device (or one or more components thereof) may receive, at a vehicle, vulnerable-road-user (VRU) information comprising a plurality of locations of a plurality of respective VRU user equipments (UEs).

At block 1904, the computing device (or one or more components thereof) may determine a region of interest (ROI) of the vehicle based on at least one of a location of the vehicle, a speed of the vehicle or a heading of the vehicle.

In some aspects, the ROI of the vehicle comprises a geometric shape around the vehicle.

In some aspects, the ROI of the vehicle comprises a geometric shape around the vehicle and the geometric shape is not centered on the vehicle based on a heading of the vehicle.

In some aspects, the ROI of the vehicle comprises a geometric shape around the vehicle and wherein a size of the geometric shape is based on a speed of the vehicle.

In some aspects, the ROI is shaped and sized based on at least one of: a speed of the vehicle; a heading of the vehicle; a planned path of the vehicle; an environment classification of a road on which the vehicle is traveling; a visibility condition relative to the road; vehicle characteristics; or driver characteristics.

At block 1906, the computing device (or one or more components thereof) may determine relevant VRU UEs from among the plurality of VRU UEs based on the ROI of the vehicle and the plurality of locations.

At block 1908, the computing device (or one or more components thereof) may display information based on positions of the relevant VRU UEs.

In some aspects, process 1900 may include controlling a vehicle based on the relevant VRU UEs.

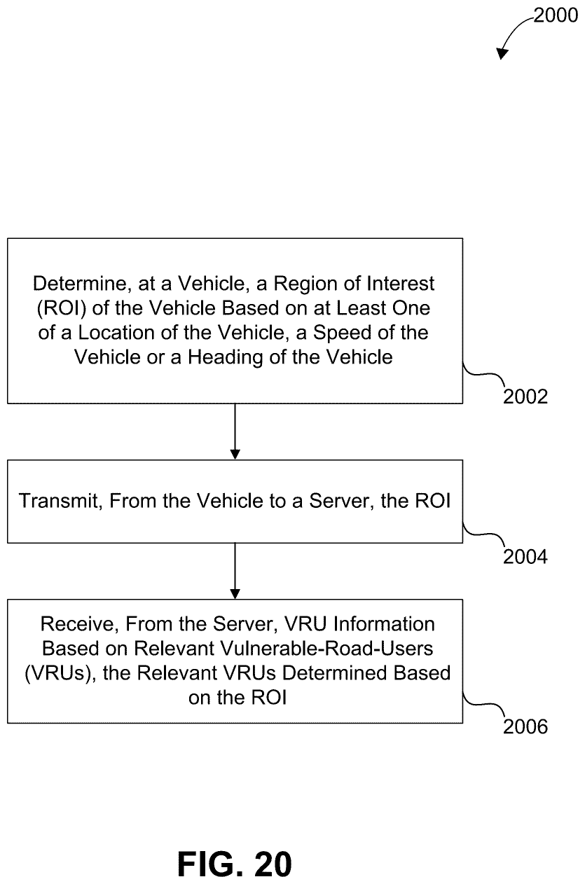

FIG. 20 is a flow diagram illustrating a process 2000 for wireless communication, in accordance with aspects of the present disclosure. One or more operations of process 2000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 2000. The one or more operations of process 2000 may be implemented as software components that are executed and run on one or more processors.

At block 2002, a computing device (or one or more components thereof) may determine, at a vehicle, a region of interest (ROI) of the vehicle based on at least one of a location of the vehicle, a speed of the vehicle or a heading of the vehicle.

At block 2004, the computing device (or one or more components thereof) may cause at least one transmitter to transmit, from the vehicle to a server, the ROI.

At block 2006, the computing device (or one or more components thereof) may receive, from the server, VRU information based on relevant vulnerable-road-users (VRUs), the relevant VRUs determined based on the ROI.

In some aspects, the ROI is shaped and sized based on at least one of: a speed of the vehicle; a heading of the vehicle; a planned path of the vehicle; an environment classification of a road on which the vehicle is traveling; a visibility condition relative to the road; vehicle characteristics; or driver characteristics.

In some aspects, the ROI may be, or may include, a current ROI based on a current time.

In some aspects, the ROI may be, or may include, a one or more predicted ROIs predicted for one or more upcoming times.

In some aspects, process 2000 may include controlling a vehicle based on the relevant VRUs.

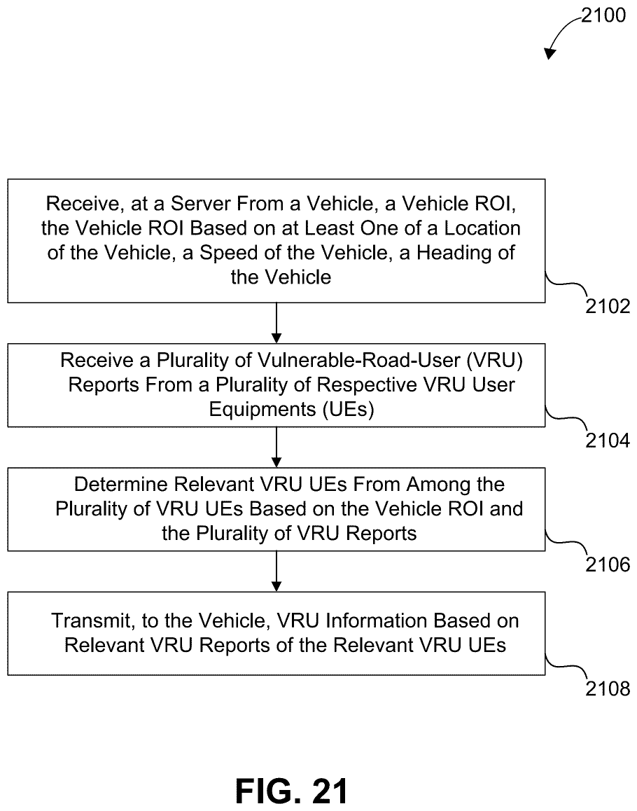

FIG. 21 is a flow diagram illustrating a process 2100 for wireless communication, in accordance with aspects of the present disclosure. One or more operations of process 2100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 2100. The one or more operations of process 2100 may be implemented as software components that are executed and run on one or more processors.

At block 2102, a computing device (or one or more components thereof) may receive, at a server from a vehicle, a vehicle ROI, the vehicle ROI based on at least one of a location of the vehicle, a speed of the vehicle, a heading of the vehicle.

At block 2104, the computing device (or one or more components thereof) may receive a plurality of vulnerable-road-user (VRU) reports from a plurality of respective VRU user equipments (UEs).

At block 2106, the computing device (or one or more components thereof) may determine relevant VRU UEs from among the plurality of VRU UEs based on the vehicle ROI and the plurality of VRU reports.

In some aspects, the vehicle ROI is shaped and sized based on at least one of: a speed of the vehicle; a heading of the vehicle; a planned path of the vehicle; an environment classification of a road on which the vehicle is traveling; a visibility condition relative to the road; vehicle characteristics; or driver characteristics.

In some aspects, the ROI may be, or may include, a current ROI based on a current time.

In some aspects, the ROI may be, or may include, a one or more predicted ROIs predicted for one or more upcoming times.

At block 2108, the computing device (or one or more components thereof) may cause at least one transmitter to transmit, to the vehicle, VRU information based on relevant VRU reports of the relevant VRU UEs.

In some aspects, a vehicle may display information, control a vehicle, or plan a path for the vehicle, based on the VRU information.

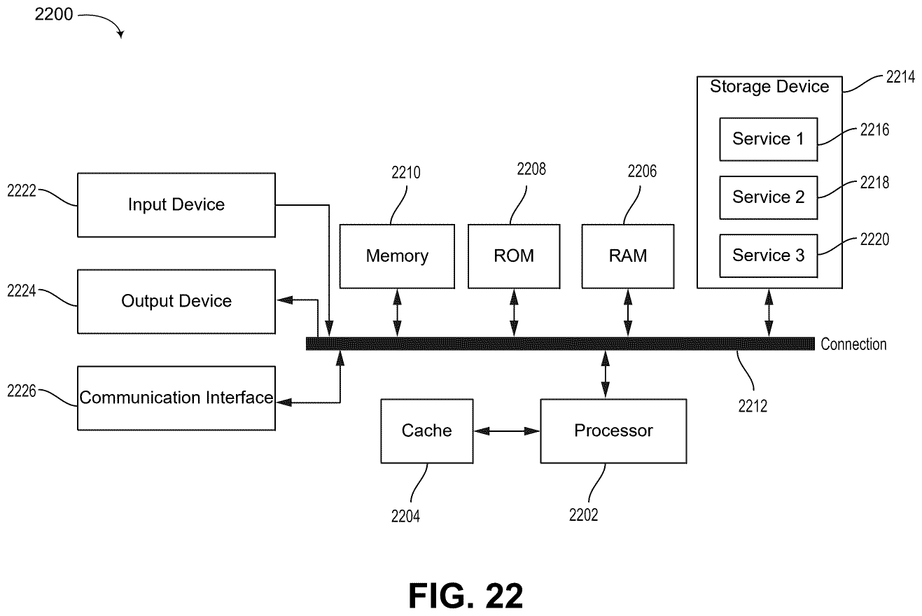

In some examples, as noted previously, the methods described herein (e.g., process 1000 of FIG. 10, process 1100 of FIG. 11, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, and/or other methods described herein) can be performed, in whole or in part, by a computing device or apparatus. In one example, one or more of the methods can be performed by system 800 of FIG. 8, VRU app 802 of FIG. 8, cloud service 808 of FIG. 8, vehicle app 810 of FIG. 8, vehicles 902 of FIG. 9, VRUs 904 of FIG. 9, vehicle 1202 of FIG. 12, VRUs 1204 of FIG. 12, VRUs 1206 of FIG. 12, vehicle 1302 of FIG. 13, VRUs 1304 of FIG. 13, VRUs 1306 of FIG. 13, VRUs 1312 of FIG. 13, VRU 1314 of FIG. 13, VRUs 1316 FIG. 13, or by another system or device. In another example, one or more of the methods (e.g., process 1000, process 1100, process 1400, process 1500, process 1600, process 1700, process 1800, process 1900, process 2000, process 2100, and/or other methods described herein) can be performed, in whole or in part, by the computing-device architecture 2200 shown in FIG. 22. For instance, a computing device with the computing-device architecture 2200 shown in FIG. 22 can include, or be included in, the components of the system 800, VRU app 802, cloud service 808, vehicle app 810, vehicles 902, VRUs 904, vehicle 1202, VRUs 1204, VRUs 1206, vehicle 1302, VRUs 1304, VRUs 1306, VRUs 1312, VRU 1314, and/or VRUs 1316 and can implement the operations of process 1000, process 1100, process 1400, process 1500, process 1600, process 1700, process 1800, process 1900, process 2000, process 2100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1000, process 1100, process 1400, process 1500, process 1600, process 1700, process 1800, process 1900, process 2000, process 2100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1000, process 1100, process 1400, process 1500, process 1600, process 1700, process 1800, process 1900, process 2000, process 2100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 22 illustrates an example computing-device architecture 2200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2200 may include, implement, or be included in any or all of system 800 of FIG. 8, VRU app 802 of FIG. 8, cloud service 808 of FIG. 8, vehicle app 810 of FIG. 8, vehicles 902 of FIG. 9, VRUs 904 of FIG. 9, vehicle 1202 of FIG. 12, VRUs 1204 of FIG. 12, VRUs 1206 of FIG. 12, vehicle 1302 of FIG. 13, VRUs 1304 of FIG. 13, VRUs 1306 of FIG. 13, VRUs 1312 of FIG. 13, VRU 1314 of FIG. 13, VRUs 1316 FIG. 13, and/or other devices, modules, or systems described herein. Additionally or alternatively, computing-device architecture 2200 may be configured to perform process 1000 of FIG. 10, process 1100 of FIG. 11, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, and/or other process described herein.

The components of computing-device architecture 2200 are shown in electrical communication with each other using connection 2212, such as a bus. The example computing-device architecture 2200 includes a processing unit (CPU or processor) 2202 and computing device connection 2212 that couples various computing device components including computing device memory 2210, such as read only memory (ROM) 2208 and random-access memory (RAM) 2206, to processor 2202.

Computing-device architecture 2200 can include a cache of high-speed memory connected directly with, in close proximity to, or integrated as part of processor 2202. Computing-device architecture 2200 can copy data from memory 2210 and/or the storage device 2214 to cache 2204 for quick access by processor 2202. In this way, the cache can provide a performance boost that avoids processor 2202 delays while waiting for data. These and other modules can control or be configured to control processor 2202 to perform various actions. Other computing device memory 2210 may be available for use as well. Memory 2210 can include multiple different types of memory with different performance characteristics. Processor 2202 can include any general-purpose processor and a hardware or software service, such as service 1 2216, service 2 2218, and service 3 2220 stored in storage device 2214, configured to control processor 2202 as well as a special-purpose processor where software instructions are incorporated into the processor design. Processor 2202 may be a self-contained system, containing multiple cores or processors, a bus, memory controller, cache, etc. A multi-core processor may be symmetric or asymmetric.

To enable user interaction with the computing-device architecture 2200, input device 2222 can represent any number of input mechanisms, such as a microphone for speech, a touch-sensitive screen for gesture or graphical input, keyboard, mouse, motion input, speech and so forth. Output device 2224 can also be one or more of a number of output mechanisms known to those of skill in the art, such as a display, projector, television, speaker device, etc. In some instances, multimodal computing devices can enable a user to provide multiple types of input to communicate with computing-device architecture 2200. Communication interface 2226 can generally govern and manage the user input and computing device output. There is no restriction on operating on any particular hardware arrangement and therefore the basic features here may easily be substituted for improved hardware or firmware arrangements as they are developed.

Storage device 2214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 2206, read only memory (ROM) 2208, and hybrids thereof. Storage device 2214 can include services 2216, 2218, and 2220 for controlling processor 2202. Other hardware or software modules are contemplated. Storage device 2214 can be connected to the computing device connection 2212. In one aspect, a hardware module that performs a particular function can include the software component stored in a computer-readable medium in connection with the necessary hardware components, such as processor 2202, connection 2212, output device 2224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for wireless communication, the method comprising: receiving, at a server, a vulnerable-road-user (VRU) report from a VRU user equipment (UE), the VRU report including information associated with at least one of a location of the VRU UE, a speed of the VRU UE, or a heading of the VRU UE; determining, based on the VRU report, VRU context information associated with the VRU UE; determining, based on the VRU context information, an updated VRU-message reporting frequency for the VRU UE; and transmitting, to the UE, information indicating the updated VRU-message reporting frequency.

Aspect 2. The method of aspect 1, wherein the VRU context information comprises at least one of: a location of the VRU UE relative to a road; a speed of the VRU UE; an environment classification of the road; or a communication protocol and/or bandwidth used to receive the VRU report.

Aspect 3. The method of any one of aspects 1 or 2, wherein determining the VRU context information is further based on at least one of: map relative to a road; other VRU reports from other VRUs in an environment; or images of the VRU obtained by a camera in the environment.

Aspect 4. The method of any one of aspects 1 to 3, wherein the VRU context information comprises an indication that the VRU UE is at least one of: on a road; proximate to the road; moving on the road; immobile at a crosswalk or intersection; speeding up; in an environment with low VRU density; travelling in a vehicle; distant from the road; not engaged in a road activity; slowing down; or in an environment with high VRU density.

Aspect 5. The method of any one of aspects 1 to 4, wherein determining the updated VRU-message reporting frequency comprises determining an increase in the updated VRU-message reporting frequency for the VRU UE based on a determination that the VRU UE is at least one of: on a road; proximate to the road; moving on the road; waiting to cross the road; speeding up; or in an environment with low VRU density.

Aspect 6. The method of any one of aspects 1 to 5, wherein determining the updated VRU-message reporting frequency comprises determining a decrease in a reporting frequency of the VRU UE based on a determination that the VRU UE is at least one of: travelling in a vehicle; distant from a road; not engaged in a road activity; slowing down; or in an environment with high VRU density.

Aspect 7. The method of any one of aspects 1 to 6, wherein the VRU UE is configured to transmit further VRU reports to the server at the updated VRU-message reporting frequency based on receiving the updated VRU-message reporting frequency from the server.

Aspect 8. A method for wireless communication, the method comprising: determining, at a vulnerable road user (VRU) user equipment (UE), VRU context information associated with the VRU UE; determining, based on the VRU context information, an updated VRU-message reporting frequency for the VRU UE; and transmitting, to a server, a VRU report according to the updated VRU-message reporting frequency, the VRU report including information associated with at least one of a location of the VRU UE, a speed of the VRU UE, or a heading of the VRU UE.

Aspect 9. The method of aspect 8, wherein the VRU context information comprises at least one of: a location of the VRU UE relative to a road; a speed of the VRU UE; an environment classification of the road; or a communication protocol and/or bandwidth used to transmit the VRU report.

Aspect 10. The method of any one of aspects 8 or 9, wherein the VRU context information comprises an indication that the VRU UE is at least one of: on a road; proximate to the road; moving on the road; immobile at a crosswalk or intersection; speeding up; in an environment with low VRU density; travelling in a vehicle; distant from the road; not engaged in a road activity; slowing down; or in an environment with high VRU density.

Aspect 11. The method of any one of aspects 8 to 10, wherein determining the updated VRU-message reporting frequency comprises determining an increase in the updated VRU-message reporting frequency for the VRU UE based on a determination that the VRU UE is at least one of: on a road; proximate to the road; moving on the road; waiting to cross the road; speeding up; or in an environment with low VRU density.

Aspect 12. The method of any one of aspects 8 to 11, wherein determining the updated VRU-message reporting frequency comprises determining a decrease in a reporting frequency of the VRU UE based on a determination that the VRU UE is at least one of: travelling in a vehicle; distant from a road; not engaged in a road activity; slowing down; or in an environment with high VRU density.

Aspect 13. A method for wireless communication, the method comprising: receiving, at a server, a vehicle report from a vehicle, the vehicle report including information associated with at least one of a location of the vehicle, a speed of the vehicle, a heading of the vehicle; determining vehicle context information associated with the vehicle based on the vehicle report; determining, based on the vehicle context information, an updated vehicle-message reporting frequency for the vehicle; and transmitting, to the vehicle, information indicating the updated vehicle-message reporting frequency.

Aspect 14. The method of aspect 13, wherein the vehicle context information comprises at least one of: a speed of the vehicle; an environment classification of a road; a visibility condition relative to the road; or a communication protocol and/or bandwidth used to receive the vehicle report.

Aspect 15. The method of any one of aspects 13 or 14, wherein the vehicle context information is further based on at least one of: map relative to a road; or weather data.

Aspect 16. The method of aspect 13, wherein the vehicle context information comprises an indication that the vehicle is at least one of: speeding up; in an environment with low vulnerable road user (VRU) density; in an urban environment; not moving; slowing down; in an environment with high VRU density; or in a suburban environment.

Aspect 17. The method of any one of aspects 13 to 16, wherein determining the updated vehicle-message reporting frequency comprises determining an increase in the updated vehicle-message reporting frequency for the vehicle based on a determination that the vehicle is at least one of: speeding up; in an environment with low vulnerable road user (VRU) density; or in an urban environment.

Aspect 18. The method of any one of aspects 13 to 17, wherein determining the updated vehicle-message reporting frequency comprises determining a decrease in the updated vehicle-message reporting frequency for the vehicle based on a determination that the vehicle is at least one of: not moving; slowing down; in an environment with high VRU density; or in a suburban environment.

Aspect 19. The method of any one of aspects 13 to 18, wherein the vehicle is configured to transmit further vehicle reports to the server at the updated vehicle-message reporting frequency based on receiving information indicating the updated vehicle-message reporting frequency from the server.

Aspect 20. A method for wireless communication, the method comprising: determining, at a vehicle, vehicle context information associated with the vehicle; determining, based on the vehicle context information, an updated vehicle-message reporting frequency for the vehicle; and transmitting, to a server, a vehicle report according to the updated vehicle-message reporting frequency, the vehicle report including information associated with at least one of a location of the vehicle, a speed of the vehicle, a heading of the vehicle.

Aspect 21. The method of aspect 20, wherein the vehicle context information comprises at least one of: a speed of the vehicle; an environment classification of a road; a visibility condition relative to the road; or a communication protocol and/or bandwidth used to transmit the vehicle report.

Aspect 22. The method of any one of aspects 20 or 21, wherein the vehicle context information is further based on at least one of: map relative to a road; or weather data.

Aspect 23. The method of any one of aspects 20 to 22, wherein the vehicle context information comprises an indication that the vehicle is at least one of: speeding up; in an environment with low vulnerable road user (VRU) density; in an urban environment; not moving; slowing down; in an environment with high VRU density; or in a suburban environment.

Aspect 24. The method of any one of aspects 20 to 23, wherein determining the updated vehicle-message reporting frequency comprises determining an increase in the updated vehicle-message reporting frequency for the vehicle based on a determination that the vehicle is at least one of: speeding up; in an environment with low vulnerable road user (VRU) density; or in an urban environment.

Aspect 25. The method of any one of aspects 20 to 24, wherein determining the updated vehicle-message reporting frequency comprises determining a decrease in the updated vehicle-message reporting frequency for the vehicle based on a determination that the vehicle is at least one of: not moving; slowing down; in an environment with high VRU density; or in a suburban environment.

Aspect 26. A method for wireless communication, the method comprising: receiving, at a server, a vehicle report from a vehicle, the vehicle report including information associated with at least one of a location of the vehicle, a speed of the vehicle, a heading of the vehicle; determining, based on the vehicle report, a region of interest (ROI) of the vehicle; receiving a plurality of vulnerable-road-user (VRU) reports from a plurality of respective VRU user equipments (UEs); determining relevant VRU UEs from among the plurality of VRU UEs based on the ROI of the vehicle and the plurality of VRU reports; and transmitting, to the vehicle, VRU information based on relevant VRU reports of the relevant VRU UEs.

Aspect 27. The method of aspect 26, wherein the ROI of the vehicle comprises a geometric shape around the vehicle.

Aspect 28. The method of any one of aspects 26 or 27, wherein the ROI of the vehicle comprises a geometric shape around the vehicle and wherein the geometric shape is not centered on the vehicle based on the heading of the vehicle.

Aspect 29. The method of any one of aspects 26 to 28, wherein the ROI of the vehicle comprises a geometric shape around the vehicle and wherein a size of the geometric shape is based on the speed of the vehicle.

Aspect 30. The method of any one of aspects 26 to 29, wherein the ROI is shaped and sized based on at least one of: the speed of the vehicle; the heading of the vehicle; a planned path of the vehicle; an environment classification of a road on which the vehicle is traveling; a visibility condition relative to the road; vehicle characteristics; or driver characteristics.

Aspect 31. A method for displaying information, the method comprising: receiving, at a vehicle, vulnerable-road-user (VRU) information comprising a plurality of locations of a plurality of respective VRU user equipments (UEs); determining a region of interest (ROI) of the vehicle based on at least one of a location of the vehicle, a speed of the vehicle or a heading of the vehicle; determining relevant VRU UEs from among the plurality of VRU UEs based on the ROI of the vehicle and the plurality of locations; and displaying information based on positions of the relevant VRU UEs.

Aspect 32. The method of aspect 31, wherein the ROI of the vehicle comprises a geometric shape around the vehicle.

Aspect 33. The method of any one of aspects 31 or 32, wherein the ROI of the vehicle comprises a geometric shape around the vehicle and wherein the geometric shape is not centered on the vehicle based on a heading of the vehicle.

Aspect 34. The method of any one of aspects 31 to 33, wherein the ROI of the vehicle comprises a geometric shape around the vehicle and wherein a size of the geometric shape is based on a speed of the vehicle.

Aspect 35. The method of any one of aspects 31 to 34, wherein the ROI is shaped and sized based on at least one of: a speed of the vehicle; a heading of the vehicle; a planned path of the vehicle; an environment classification of a road on which the vehicle is traveling; a visibility condition relative to the road; vehicle characteristics; or driver characteristics.

Aspect 36. A method for wireless communication, the method comprising: determining, at a vehicle, a region of interest (ROI) of the vehicle based on at least one of a location of the vehicle, a speed of the vehicle or a heading of the vehicle; transmitting, from the vehicle to a server, the ROI; receiving, from the server, VRU information based on relevant vulnerable-road-users (VRUs), the relevant VRUs determined based on the ROI.

Aspect 37. The method of aspect 36, wherein the ROI is shaped and sized based on at least one of: a speed of the vehicle; a heading of the vehicle; a planned path of the vehicle; an environment classification of a road on which the vehicle is traveling; a visibility condition relative to the road; vehicle characteristics; or driver characteristics.

Aspect 38. The method of any one of aspects 36 or 37, wherein the ROI comprises a current ROI based on a current time.

Aspect 39. The method of any one of aspects 36 to 38, wherein the ROI comprises a one or more predicted ROIs predicted for one or more upcoming times.

Aspect 40. A method for wireless communication, the method comprising: receiving, at a server from a vehicle, a vehicle ROI, the vehicle ROI based on at least one of a location of the vehicle, a speed of the vehicle, a heading of the vehicle; receiving a plurality of vulnerable-road-user (VRU) reports from a plurality of respective VRU user equipments (UEs); determining relevant VRU UEs from among the plurality of VRU UEs based on the vehicle ROI and the plurality of VRU reports; and transmitting, to the vehicle, VRU information based on relevant VRU reports of the relevant VRU UEs.

Aspect 41. The method of aspect 40, wherein the vehicle ROI is shaped and sized based on at least one of: a speed of the vehicle; a heading of the vehicle; a planned path of the vehicle; an environment classification of a road on which the vehicle is traveling; a visibility condition relative to the road; vehicle characteristics; or driver characteristics.

Aspect 42. The method of any one of aspects 40 or 41, wherein the ROI comprises a current ROI based on a current time.

Aspect 43. The method of any one of aspects 40 to 42, wherein the ROI comprises a one or more predicted ROIs predicted for one or more upcoming times.

Aspect 44. An apparatus for wireless communication, the apparatus comprising: at least one memory; and at least one processor coupled to the at least one memory and configured to: receive, at a server, a vulnerable-road-user (VRU) report from a VRU user equipment (UE), the VRU report including information associated with at least one of a location of the VRU UE, a speed of the VRU UE, or a heading of the VRU UE; determine, based on the VRU report, VRU context information associated with the VRU UE; determine, based on the VRU context information, an updated VRU-message reporting frequency for the VRU UE; and cause at least one transmitter to transmit, to the UE, information indicating the updated VRU-message reporting frequency.

Aspect 45. The apparatus of aspect 44, wherein the at least one processor is configured to perform the method of any one of claims 2 to 7.

Aspect 46. An apparatus for wireless communication, the apparatus comprising: at least one memory; and at least one processor coupled to the at least one memory and configured to: determine, at a vulnerable road user (VRU) user equipment (UE), VRU context information associated with the VRU UE; determine, based on the VRU context information, an updated VRU-message reporting frequency for the VRU UE; and cause at least one transmitter to transmit, to a server, a VRU report according to the updated VRU-message reporting frequency, the VRU report including information associated with at least one of a location of the VRU UE, a speed of the VRU UE, or a heading of the VRU UE.

Aspect 47. The apparatus of aspect 46, wherein the at least one processor is configured to perform the method of any one of claims 9 to 12.

Aspect 48. An apparatus for wireless communication, the apparatus comprising: at least one memory; and at least one processor coupled to the at least one memory and configured to: receive, at a server, a vehicle report from a vehicle, the vehicle report including information associated with at least one of a location of the vehicle, a speed of the vehicle, a heading of the vehicle; determine vehicle context information associated with the vehicle based on the vehicle report; determine, based on the vehicle context information, an updated vehicle-message reporting frequency for the vehicle; and cause at least one transmitter to transmit, to the vehicle, information indicating the updated vehicle-message reporting frequency.

Aspect 49. The apparatus of aspect 48, wherein the at least one processor is configured to perform the method of any one of claims 14 to 19.

Aspect 50. An apparatus for wireless communication, the apparatus comprising: at least one memory; and at least one processor coupled to the at least one memory and configured to: determine, at a vehicle, vehicle context information associated with the vehicle; determine, based on the vehicle context information, an updated vehicle-message reporting frequency for the vehicle; and cause at least one transmitter to transmit, to a server, a vehicle report according to the updated vehicle-message reporting frequency, the vehicle report including information associated with at least one of a location of the vehicle, a speed of the vehicle, a heading of the vehicle.

Aspect 51. The apparatus of aspect 50, wherein the at least one processor is configured to perform the method of any one of claims 21 to 25.

Aspect 52. An apparatus for wireless communication, the apparatus comprising: at least one memory; and at least one processor coupled to the at least one memory and configured to: receive, at a server, a vehicle report from a vehicle, the vehicle report including information associated with at least one of a location of the vehicle, a speed of the vehicle, a heading of the vehicle; determine, based on the vehicle report, a region of interest (ROI) of the vehicle; receive a plurality of vulnerable-road-user (VRU) reports from a plurality of respective VRU user equipments (UEs); determine relevant VRU UEs from among the plurality of VRU UEs based on the ROI of the vehicle and the plurality of VRU reports; and cause at least one transmitter to transmit, to the vehicle, VRU information based on relevant VRU reports of the relevant VRU UEs.

Aspect 53. The apparatus of aspect 52, wherein the at least one processor is configured to perform the method of any one of claims 27 to 30.

Aspect 54. An apparatus for displaying information, the apparatus comprising: at least one memory; and at least one processor coupled to the at least one memory and configured to: receive, at a vehicle, vulnerable-road-user (VRU) information comprising a plurality of locations of a plurality of respective VRU user equipments (UEs); determine a region of interest (ROI) of the vehicle based on at least one of a location of the vehicle, a speed of the vehicle or a heading of the vehicle; determine relevant VRU UEs from among the plurality of VRU UEs based on the ROI of the vehicle and the plurality of locations; and display information based on positions of the relevant VRU UEs.

Aspect 55. The apparatus of aspect 54, wherein the at least one processor is configured to perform the method of any one of claims 32 to 35.

Aspect 56. An apparatus for wireless communication, the apparatus comprising: at least one memory; and at least one processor coupled to the at least one memory and configured to: determine, at a vehicle, a region of interest (ROI) of the vehicle based on at least one of a location of the vehicle, a speed of the vehicle or a heading of the vehicle; cause at least one transmitter to transmit, from the vehicle to a server, the ROI; receive, from the server, VRU information based on relevant vulnerable-road-users (VRUs), the relevant VRUs determined based on the ROI.

Aspect 57. The apparatus of aspect 56, wherein the at least one processor is configured to perform the method of any one of claims 37 to 39.

Aspect 58. An apparatus for wireless communication, the apparatus comprising: at least one memory; and at least one processor coupled to the at least one memory and configured to: receive, at a server from a vehicle, a vehicle ROI, the vehicle ROI based on at least one of a location of the vehicle, a speed of the vehicle, a heading of the vehicle; receive a plurality of vulnerable-road-user (VRU) reports from a plurality of respective VRU user equipments (UEs); determine relevant VRU UEs from among the plurality of VRU UEs based on the vehicle ROI and the plurality of VRU reports; and cause at least one transmitter to transmit, to the vehicle, VRU information based on relevant VRU reports of the relevant VRU UEs.

Aspect 59. The apparatus of aspect 58, wherein the at least one processor is configured to perform the method of any one of claims 41 to 43.

Aspect 60. A non-transitory computer-readable storage medium having stored thereon instructions that, when executed by at least one processor, cause the at least one processor to perform operations according to any of aspects 1 to 43.

Aspect 61. An apparatus for wireless communication, the apparatus comprising one or more means for perform operations according to any of aspects 1 to 43.

What is claimed is:

1. An apparatus for wireless communication, the apparatus comprising:
at least one memory; and
at least one processor coupled to the at least one memory and configured to:
receive a vulnerable-road-user (VRU) report from a VRU user equipment (UE), the VRU report including information associated with at least one of a location of the VRU UE, a speed of the VRU UE, or a heading of the VRU UE;
determine, based on the VRU report, VRU context information associated with the VRU UE;
determine, based on the VRU context information, an updated VRU-message reporting frequency for the VRU UE; and
cause at least one transmitter to transmit, to the UE, information indicating the updated VRU-message reporting frequency.

2. The apparatus of claim 1, wherein the VRU context information comprises at least one of:
a location of the VRU UE relative to a road;
a speed of the VRU UE;
an environment classification of the road; or
a communication protocol and/or bandwidth used to receive the VRU report.

3. The apparatus of claim 1, the VRU context information is determined further based on at least one of:
map relative to a road;
other VRU reports from other VRUs in an environment; or
images of the VRU obtained by a camera in the environment.

4. The apparatus of claim 1, wherein the VRU context information comprises an indication that the VRU UE is at least one of:
on a road;
proximate to the road;
moving on the road;
immobile at a crosswalk or intersection;
speeding up;
in an environment with low VRU density;
travelling in a vehicle;
distant from the road;
not engaged in a road activity;
slowing down; or
in an environment with high VRU density.

5. The apparatus of claim 1, wherein the at least one processor is configured to determine an increase in the updated VRU-message reporting frequency for the VRU UE based on a determination that the VRU UE is at least one of:
on a road;
proximate to the road;
moving on the road;
waiting to cross the road;
speeding up; or
in an environment with low VRU density.

6. The apparatus of claim 1, wherein the at least one processor is configured to determine a decrease in a reporting frequency of the VRU UE based on a determination that the VRU UE is at least one of:
travelling in a vehicle;
distant from a road;
not engaged in a road activity;
slowing down; or
in an environment with high VRU density.

7. The apparatus of claim 1, wherein the VRU UE is configured to transmit further VRU reports at the updated VRU-message reporting frequency based on receiving the updated VRU-message reporting frequency from the apparatus.

8. An apparatus for wireless communication, the apparatus comprising:
at least one memory; and
at least one processor coupled to the at least one memory and configured to:
determine vulnerable-road-user (VRU) context information associated with a VRU user equipment (UE);
determine, based on the VRU context information, an updated VRU-message reporting frequency for the VRU UE; and
cause at least one transmitter to transmit, to a server, a VRU report according to the updated VRU-message reporting frequency, the VRU report including information associated with at least one of a location of the VRU UE, a speed of the VRU UE, or a heading of the VRU UE.

9. The apparatus of claim 8, wherein the VRU context information comprises at least one of:
a location of the VRU UE relative to a road;
a speed of the VRU UE;
an environment classification of the road; or
a communication protocol and/or bandwidth used to transmit the VRU report.

10. The apparatus of claim 8, wherein the VRU context information comprises an indication that the VRU UE is at least one of:
on a road;
proximate to the road;
moving on the road;
immobile at a crosswalk or intersection;
speeding up;
in an environment with low VRU density;
travelling in a vehicle;
distant from the road;
not engaged in a road activity;
slowing down; or
in an environment with high VRU density.

11. The apparatus of claim 8, wherein the at least one processor is configured to determine an increase in the updated VRU-message reporting frequency for the VRU UE based on a determination that the VRU UE is at least one of:
on a road;
proximate to the road;
moving on the road;
waiting to cross the road;
speeding up; or
in an environment with low VRU density.

12. The apparatus of claim 8, wherein the at least one processor is configured to determine a decrease in a reporting frequency of the VRU UE based on a determination that the VRU UE is at least one of:
travelling in a vehicle;
distant from a road;
not engaged in a road activity;
slowing down; or
in an environment with high VRU density.

13. The apparatus of claim 8, wherein the at least one processor is configured to determine a cessation in reporting of the VRU UE based on a determination that the VRU UE is at least one of:
travelling in a vehicle;
distant from a road;
not engaged in a road activity;
slowing down; or
in an environment with high VRU density.

14. The apparatus of claim 8, wherein the VRU context information comprises first VRU content information, wherein the updated VRU-message reporting frequency comprises a first VRU-message reporting frequency, and wherein the at least one processor is configured to:
determine second VRU context information associated with the VRU UE;
determine, based on the second VRU context information, a second updated VRU-message reporting frequency for the VRU UE; and
cause the at least one transmitter to transmit, to a server, the VRU report according to the second updated VRU-message reporting frequency.

15. An apparatus for wireless communication, the apparatus comprising:
at least one memory; and
at least one processor coupled to the at least one memory and configured to:
receive a vehicle report from a vehicle, the vehicle report including information associated with at least one of a location of the vehicle, a speed of the vehicle, a heading of the vehicle;
determine vehicle context information associated with the vehicle based on the vehicle report;
determine, based on the vehicle context information, an updated vehicle-message reporting frequency for the vehicle; and
cause at least one transmitter to transmit, to the vehicle, information indicating the updated vehicle-message reporting frequency.

16. The apparatus of claim 15, wherein the vehicle context information comprises at least one of:
a speed of the vehicle;
an environment classification of a road;
a visibility condition relative to the road; or
a communication protocol and/or bandwidth used to receive the vehicle report.

17. The apparatus of claim 15, wherein the vehicle context information is further based on at least one of:
map relative to a road; or
weather data.

18. The apparatus of claim 15, wherein the vehicle context information comprises an indication that the vehicle is at least one of:
speeding up;
in an environment with low vulnerable road user (VRU) density;
in an urban environment;
not moving;
slowing down;
in an environment with high VRU density; or
in a suburban environment.

19. The apparatus of claim 15, wherein the at least one processor is configured to determine an increase in the updated vehicle-message reporting frequency for the vehicle based on a determination that the vehicle is at least one of:
speeding up;
in an environment with low vulnerable road user (VRU) density; or
in an urban environment.

20. The apparatus of claim 15, wherein the at least one processor is configured to determine a decrease in the updated vehicle-message reporting frequency for the vehicle based on a determination that the vehicle is at least one of:
not moving;
slowing down;
in an environment with high VRU density; or
in a suburban environment.
